(19) United States
(12) Patent Application Publication
(10) Pub. No.: US 2014/0365644 A1
(43) Pub. Date: Dec. 11, 2014

(54) INTERNET TRAFFIC ANALYTICS FOR NON-INTERNET TRAFFIC

(71) Applicant: Bay Sensors, Palo Alto, CA (US)

(72) Inventors: Greg Tanaka, Palo Alto, CA (US); Rudi Cilibrasi, Sunnyvale, CA (US)

(73) Assignee: Bay Sensors, Palo Alto, CA (US)

(21) Appl. No.: 14/273,981

(22) Filed: May 9, 2014

Related U.S. Application Data
(60) Provisional application No. 61/821,629, filed on May 9, 2013.

(51) Int. Cl. H04L 12/26; H04L 29/08

(52) U.S. Cl. CPC H04L 43/0876; H04L 67/02
USPC 709/224

(57) ABSTRACT

A method for collecting and analyzing countable physical event data can be provided. A large number of countable physical events can be detected with one or more electronic sensors. In response to substantially all the detected physical events, electronic internet requests can be generated. The electronic internet requests can then be representative of the detected physical events. Then, processed data generated from the electronic internet requests can be received and said processed data can be representative of the detected physical events. For example, in some embodiments data regarding the electronic internet requests can be processed by internet traffic analytics software.

### INCORPORATION BY REFERENCE TO ANY PRIORITY APPLICATIONS

This application claims the priority benefit under 35 U.S.C. §119(e) to U.S. Provisional Patent Application Ser. No. 61/821,629 (filed 9 May 2013), titled “Automatic Transmission of Arbitrary Counting Event Data Over Pre-Existing Website Analytic Infrastructure,” and listing Greg Tanaka and Rudi Calibrasi as inventors, the entirety of which is hereby expressly incorporated by reference herein.

### BACKGROUND OF THE INVENTIONS

1. Field of the Inventions

Embodiments disclosed herein are related to communication devices, and more particularly to apparatuses, systems, and methods for data-analysis of non-internet traffic using tools developed for data-analysis of internet traffic. Particular attention is directed toward the use of such techniques for analysis of physical traffic in retail settings.

2. Description of the Related Art

To best service customers and other visitors, venues such as retail stores and event centers might consider gathering information about their visitors. This information can be used for a wide variety of ways to improve customer service, inventory management, profitability, and other aspects important to businesses. A variety of data analysis solutions have been developed for internet traffic. However, solutions for non-internet traffic are relatively undeveloped.

### SUMMARY OF THE INVENTIONS

In one embodiment, a system for automatic visitor monitoring comprises one or more sensors and a processor. The one or more sensors can be configured to automatically generate electronic sensor data regarding visitors at a venue. The processor can be configured to process the electronic sensor data to identify one or more visitors. The processor can also be configured to identify one or more characteristics of the behavior of the one or more visitors or devices carried by said visitors. Even further, the processor can be configured to determine if two or more visitors are part of a single visitor group unit.

In a further embodiment, a method for automatically monitoring visitors at a venue can be provided. Electronic sensor data regarding visitors at a venue can be automatically generated. The electronic sensor data can be processed to identify one or more visitors at the venue. Further, one or more characteristics of the behavior of the visitors or devices carried by the visitors can be analyzed to determine if two or more of said visitors are part of a single visitor group unit.

In a further embodiment, a method of developing a system to identify humans and human behavior is provided. A large number of images or videos can be collected, a plurality of said images including one or more people. The images or videos can be used as an internet CAPTCHA, requiring human testers to identify at least one of if a person is in the image or video, if a person is in the image or video at a particular place, or if a person in the image or video is performing a particular action. Responses from said internet CAPTCHA can then be used to train a machine learning algorithm to identify the at least one of if a person is in the image or video, if a person is in the image or video at a particular place, or if a person in the image or video is performing a particular action.

In a further embodiment, a smart label system can comprise a plurality of products disposed in a retail space, a plurality of smart labels, and a server. The plurality of smart labels can be disposed in close physical proximity to associated products such that a specific smart label can provide information to a visitor about the specific product in close physical proximity. Further, the smart labels can comprise an electronic screen configured to provide visual information to a visitor. The smart labels can also comprise a processor configured to update information provided on the electronic screen. The server can be in electronic communication with the plurality of smart labels and configured to communicate with the processors to control the smart labels.

In a further embodiment, a method for identifying multiple aspects of a single visitor can be provided. An image of a visitor using a camera can be acquired and a known position and orientation of the camera can be used to identify a location of the visitor at the time of the image. Further, at least one other electronic sensor can be used to identify a visitor at the same position and time as the image. The image and data from the at least one other electronic sensor can then be associated in an electronic database of visitors.

In a further embodiment, a visitor monitoring device comprises a chipset, a housing, a camera, a WiFi module, and a tracklight mounting. The chipset can be disposed in the housing and the camera can be attached to the housing and configured to view one or more visitors in a venue. The WiFi module can also be disposed within the housing and also be configured to communicate wirelessly with a server. The tracklight mounting can be configured to attach the housing to a tracklight fixture.

In a further embodiment, a method for collecting and analyzing countable physical event data can be provided. A large number of countable physical events can be detected with one or more electronic sensors. In response to substantially all the detected physical events, electronic internet requests can be generated. The electronic internet requests can then be representative of the detected physical events. Then, processed data generated from the electronic internet requests can be received and said processed data can be representative of the detected physical events. For example, in some embodiments data regarding the electronic internet requests can be processed by internet traffic analytics software.

In a further embodiment, a system for analyzing countable physical event data can comprise one or more electronic devices and an internet server. The one or more electronic devices can be disposed about a physical venue and comprise one or more electronic sensors configured to detect a large number of countable physical events. The one or more electronic devices can also be configured to automatically generate a plurality of electronic internet requests in response to detecting the countable physical events. The internet server can be configured to receive the electronic internet requests at one or more electronic internet locations associated with said physical events. The internet server can also be configured to use internet traffic analytics software to generate processed data indicative of the countable physical events.

In a further embodiment, a system for analyzing countable physical event data can comprise a means for monitoring a venue and detecting a large number of physical events. The system can also comprise a means for analyzing said physical events using internet traffic analytics software.

### BRIEF DESCRIPTION OF THE DRAWINGS

FIG. 1A is a block diagram of a device for visual monitoring according to one embodiment.

FIG. 1B is a block diagram of a device for visual monitoring according to another embodiment.

FIGS. 1C and 1D are schematic drawings of a device for visual monitoring according to one embodiment.

FIG. 1E is a schematic drawing of a device for visual monitoring and its placement according to one embodiment.

FIG. 2 is a schematic drawing of a device for visual monitoring according to another embodiment.

FIG. 3 is a block diagram of a FPGA chip in a device for visual monitoring according to one embodiment.

FIGS. 4A-4C are schematic diagrams of devices for visual monitoring and their placements according to embodiments.

FIG. 5A is a block diagram of a packet-based network communicatively coupled to a device for visual monitoring according to one embodiment.

FIGS. 5B and 5C are block diagrams illustrating a software stack in a device for visual monitoring and software engines in the packet-based network according to embodiments.

FIG. 6A is a flowchart illustrating a method for visual monitoring according to embodiments.

FIG. 6B is a schematic diagram illustrating images taken by a device for visual monitoring according to embodiments.

FIGS. 7A and 7B are flowcharts illustrating methods for visual monitoring performed by a device for visual monitoring and by a server, respectively, according to embodiments.

FIG. 7C illustrate a software stack at a server with which a device for visual monitoring is communicating according to embodiments.

FIG. 8 is a flowchart illustrating a method for software updating at a device for visual monitoring according to an embodiment.

FIG. 9 is a flow chart illustrating a method for WiFi hookup at a device for visual monitoring according to an embodiment.

FIG. 10 is a flow chart illustrating a method for providing hotspot service at a device for visual monitoring according to an embodiment.

FIG. 11 is a block diagram of a software stack at a device for visual monitoring according to an embodiment.

FIG. 12A is a schematic diagram of field of view of a device for visual monitoring and triplines defined in the field of view according to an embodiment.

FIG. 12B is a schematic diagram of a tripline image according to an embodiment.

FIG. 12C is an exemplary tripline image.

FIGS. 13A-13C illustrate embodiments of a device for visual monitoring also used as a smart label.

FIG. 14 illustrates another embodiment of a device for visual monitoring also used as a smart label.

FIGS. 15 and 16 illustrate an embodiment device for visual monitoring mounted to a tracklight fixture.

FIG. 17 illustrates an embodiment system for using internet traffic analytics software to analyze non-internet events.

FIG. 18 illustrates an embodiment method for using internet traffic analytics software to analyze non-internet events.

### DETAILED DESCRIPTION OF THE PREFERRED EMBODIMENTS

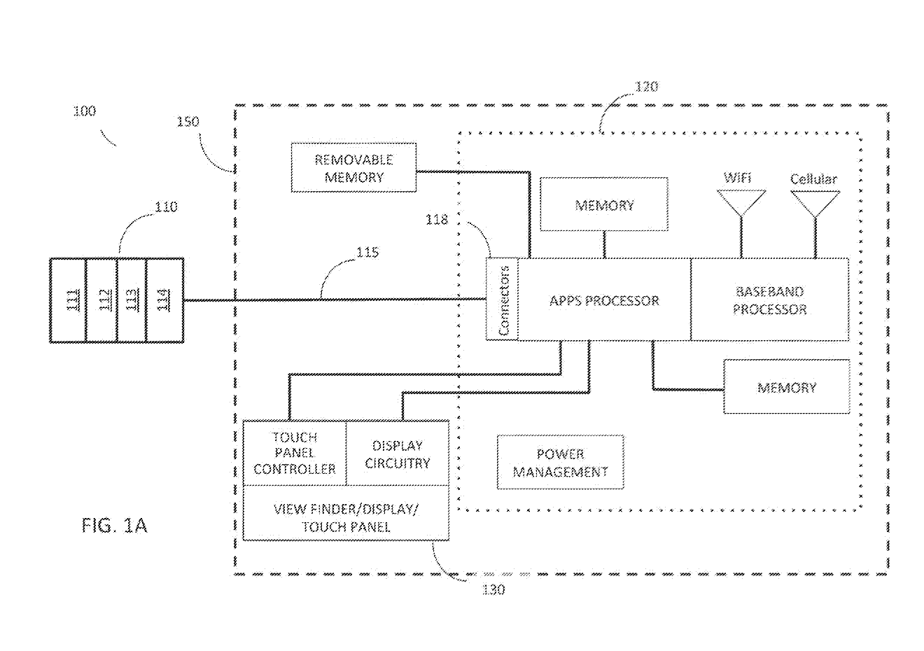

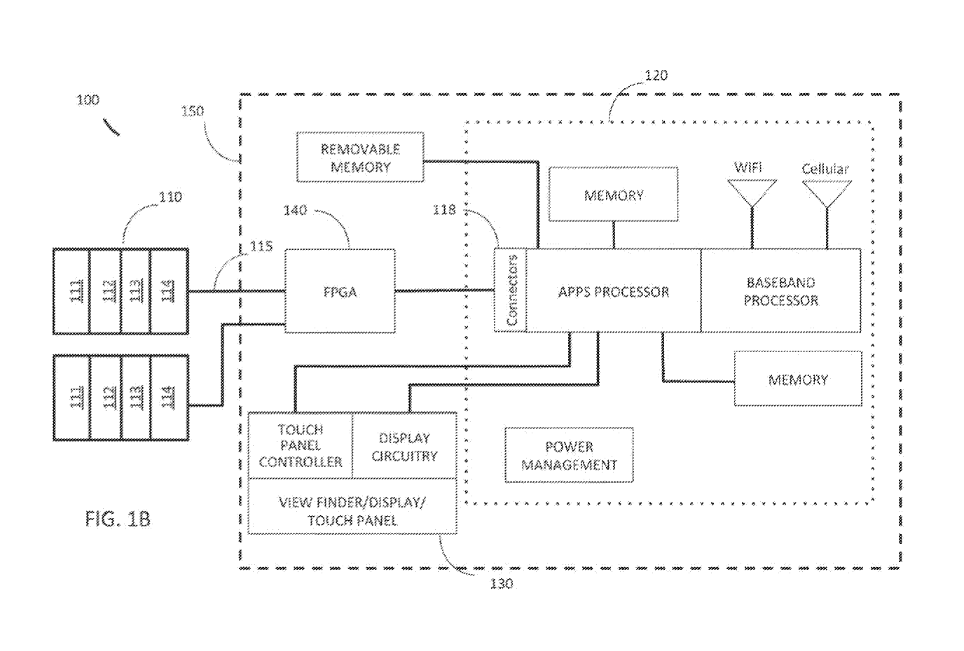

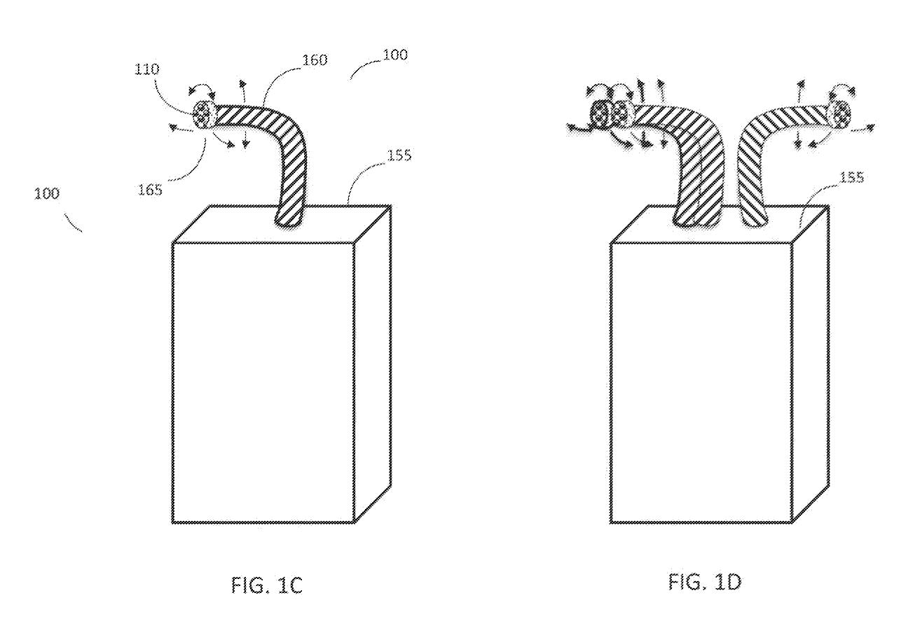

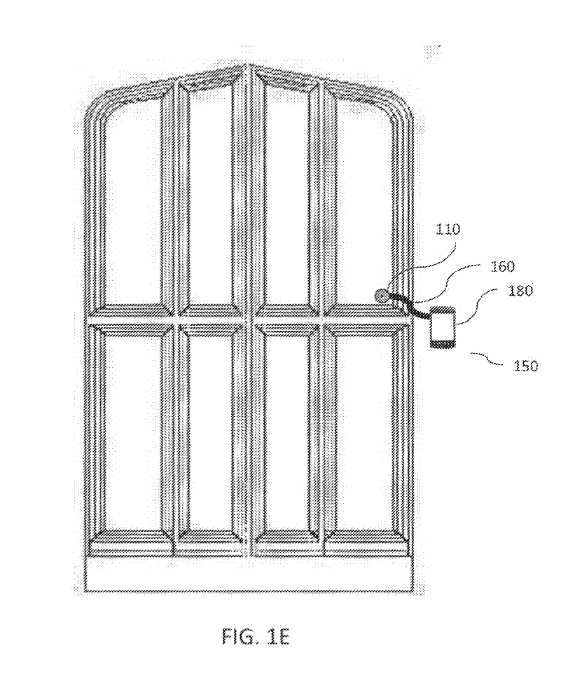

As illustrated in FIG. 1A, in one embodiment, a device for visual monitoring (VM device) 100 includes one or more camera heads 110 and a camera body 150. The camera body includes a mobile (or wireless) chipset 120, and optional display/input module 130. The camera heads and the mobile chipset are communicatively coupled via connections 115. Each camera head (or camera) 110 in turn includes one or more apertures 111, one or more lenses 112, one or more sensors 113, and connectors 114 coupled to connections 115. The one or more apertures 111 and lenses 112 can be in a different order than shown and can be interspersed to create a multi-aperture camera. The mobile chipset 120 can be any chipset designed for use in a mobile device such as a smartphone, personal digital assistant (PDA) device, or any other mobile computing device, and includes a group of integrated circuits, or chips, that are designed to work together in a mobile device. In one embodiment, the mobile chipset includes one or more processors, such as an apps processor and/or a baseband processor. The apps processor is coupled to the camera 110 via connectors 118, which is coupled to connections 115. Mobile chipset 120 can further include one or more memory components for storing data and program codes. The apps processor executes application programs stored in one or more of the memory components to process sounds, images, and/or videos captured by the camera 110. The memory components can include one or more memory chips including dynamic random access memory (DRAM) and/or flash memory. The VM device 100 can further include one or more removable memory components, which can come in the form of one or more memory cards, such as SD cards, and can be used to store sounds, images, and/or videos captured by camera 110 and/or processed by the apps processor. The baseband processor processes communication functions (not shown) in order to transmit images processed by the apps processor via a local area wireless (e.g. Wi-Fi) communication and/or a wide area network (e.g. cellular) communication. The mobile chipset 120 can further include a power management module coupled to a battery (not shown) and/or an external power source (not shown). The power management module can manage and supply power to the electronic components in the VM device 100. The VM device 100 can also include one or more batteries and/or a power adaptor that converts AC power to DC power for use by the VM device.

The optional display/input module 130 can include a display (e.g., a LCD display) that displays preview images, still pictures and/or videos captured by camera 110 and/or processed by the apps processor, a touch panel controller (if the display is also used as an input device), and display circuitry.

In some embodiments, the camera body includes all or part of a mobile device, such as a smartphone, personal digital assistant (PDA) device, or any other mobile computing device.

In some embodiments, when the VM device 100 includes more than one camera, as shown in FIG. 1B, the VM device can also include a field-programmable gate array (FPGA) chip 140 coupled between the cameras and the mobile chipset. The FPGA chip can be used to multiplex signals between the cameras and the apps processor, and to perform certain image processing functions, as discussed below.

In some embodiments, camera 110 and camera body 150 can be disposed in a single housing (not shown). In some embodiments, as shown in FIGS. 1C and 1D, the one or more cameras 110 are disposed at the heads of one or more support stalks 160, while the camera body 150 is disposed in a separate housing 155. In some embodiments, the housing is weather proof so the VM device 100 can be mounted outdoors. The stalks are flexible so that the heads can be positioned to face different directions giving a wider field of view. Furthermore, the cameras disposed in one or more protective housing 165 with transparent face and/or a sun visor (not shown), and mechanisms are provided to allow the camera(s) to swivel so that the images captured by the camera can be kept oriented correctly no matter which direction the camera is facing. This swivel motion can be limited (e.g. plus or minus 180 degrees) with pins as stops so that the cable inside of the stalk does not become too twisted. In addition, the sun visor will also be able to swivel so that the top part shields the lens from the sun. The stalks and the swivel head allow cameras 110 to be positioned to capture desired images without moving the body 155 of the VM device 100. In some embodiments, the wired connections 115 shown in FIGS. 1A and 1B include a flexible cable inside the stalks. The stalks can be stiff enough to support their own weight and resist wind forces. For ease of discussion, the camera(s) on a stalk, the camera housing at the stalk head, the swivel mechanism (if provided), and the cables in the stalk are together called an eyestalk herein.

In some embodiments, as shown in FIG. 1E, the “eyestalk” is an extension of a camera of a smartphone, creating a smaller visible footprint in, for example, a store display. A conventional smartphone has the camera fixed to the body of the smartphone. To create an eyestalk, a stalk 160 in the form of an extension cable is added between the camera and the rest of the smartphone 180, so that the camera can be extended away from the smartphone 180. The smartphone 180 can be mounted away from view, while the camera can be extended via its stalk into the viewing area of the store display or at a small corner of a store window. This way the smartphone has access to the view outside the venue, but only the camera is visible. Since the size of the camera is much smaller than the rest of the smartphone, the camera 110 takes a very small footprint in a store display.

In one embodiment, the camera 110 can include one or more fish eye lenses via an enclosing mount. The mount will serve the purposes of: 1) holding the fish eye lens in place; 2) mounting the whole camera 110 to a window with an adhesive tape; 3) protecting the smartphone; and 4) angling the camera slightly downwards or in other directions to get a good view of the store front. The fish eye lens will allow a wide field of view (FOV) so that as long as the mount is placed around human eye level, the VM device 100 can be used for counting or moving objects via a tripline method, as discussed below. This allows for the VM device 100 to be easily installed. A user simply needs to peel off the adhesive tape, mount the device around eye level to the inside window of a store display, and plug into a power supply. Optionally, the VM device 100 can be connected to a WiFi hotspot, as discussed below. Otherwise, cellular connection, such as 3G, will be used by the VM device 100 as default.

In other embodiments, camera 110 is connected to the camera body via wireless connections (e.g., Bluetooth connection, Wi-Fi, etc.). In some embodiments, VM device 100 is a fixed install unit for installing on a stationary object.

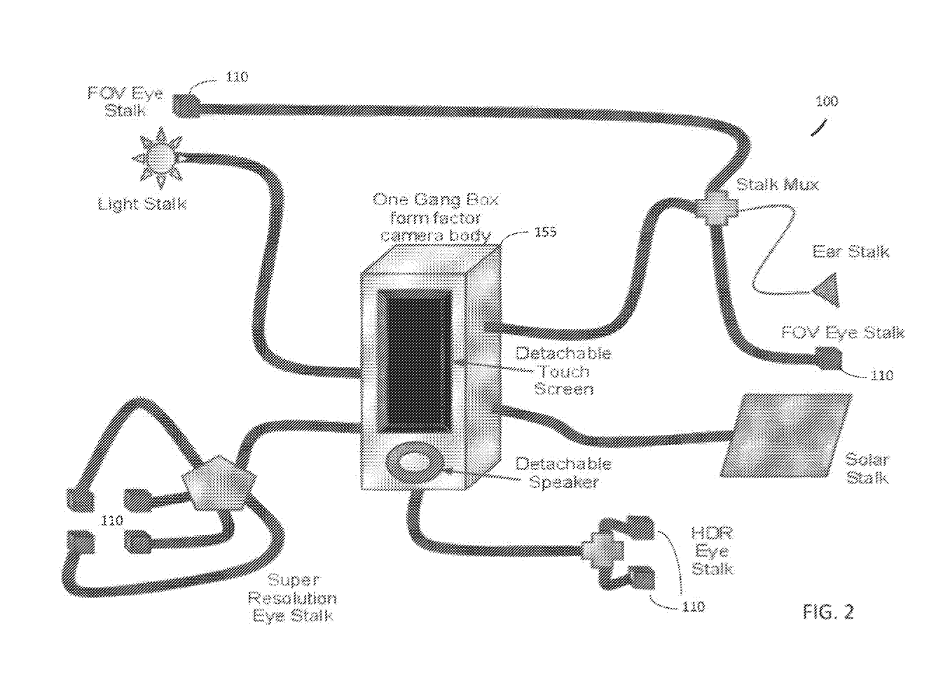

FIG. 2 illustrates VM device 100 according to some embodiments. As shown in FIG. 2, VM device 100 can include a plurality of eyestalks, a light stalk that provides illumination, and a solar stalk that provides power for the VM device 100. As shown in FIG. 2, multiple eyestalks can be connected to the camera body via a stalk multiplexer (mux). The stalk mux can include a field programmable gate array (FPGA) and/or other type of circuit embodiment (e.g. ASIC) (not shown) that is coupled between camera 110 and the apps processor. Alternatively, the stalk mux can be part of the camera body and can include a field programmable gate array (FPGA) or other type of circuit embodiment (e.g. ASIC) (not shown) that is coupled between camera 110 and the apps processor. Additionally or alternatively, multiple cameras can be used to form a high dynamic range (HDR) eyestalk, low light eyestalks, clock phase shifted high-speed camera eyestalk, and/or a super resolution eyestalk configurations. Coded apertures (not shown) and/or structured light (not shown) can also be used to enhance the pictures from the cameras. There can also be a field of view (FOV) eyestalk by having the cameras pointed in different directions. To handle the higher pixel rate caused by multiple eyestalks, compressive sensing/sampling is used to randomly sub-sample the cameras spatially and temporally. The random sub-sample can happen by having identical hash functions that generates quasi-random pixel addresses on both the camera and device reconstructing the image. Another way is for the FPGA to randomly address the camera pixel array. Yet another way is for the FPGA to randomly skip pixels sent by the camera module. The compressively sampled picture can then be reconstructed or object recognition can be done either at the VM device or in the cloud. Another way of handling the higher pixel rate of multiple eyestalks with the processing power normally used for one eyestalk is to JPEG compress each of the pictures at the camera so that the data rate at the apps processor is considerably less. Alternatively, the FPGA can read the full pixel data from all the cameras and then compress the data down before it is sent to the apps processor. Another alternative is for the FPGA to calculate visual descriptors from each of the eyestalks and then send the visual descriptors to the apps processor. For field of view eyestalks, a smaller rectangular section of the eyestalks can be retrieved from the eyestalk and sent to the apps processor. Another alternative is for the FPGA or Apps processor to extract and send only patches of the picture containing relevant information (e.g., a license plate image patch vs. a whole scene in a traffic-related application). A detachable viewfinder/touchscreen can also be tethered permanently or temporarily as another stalk or attached to the camera body. There can also be a cover for the viewfinder/touchscreen to protect it. In some embodiments, the camera body 150 with the viewfinder/touchscreen is enclosed in a housing 155, which can be weather-proof and which can include a window for the view-finder. The view finder can be activated when the camera is first powered on for installation, when is display is activated over a network, and/or when the camera is shaken and the camera accelerometer senses the motion.

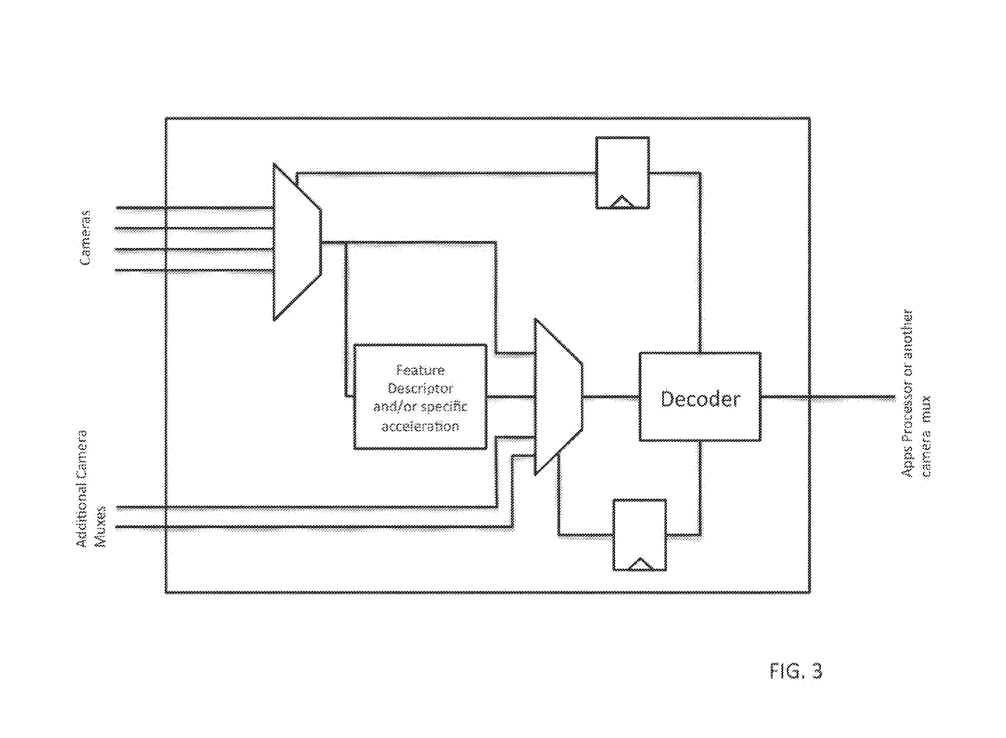

FIG. 3 is a schematic diagram of the FPGA chip 140 coupled between multiple cameras and the apps processor. The FPGA chip 140 can be placed inside the housing 155 of the camera body 155 or close to the cameras 110 in a separate housing.

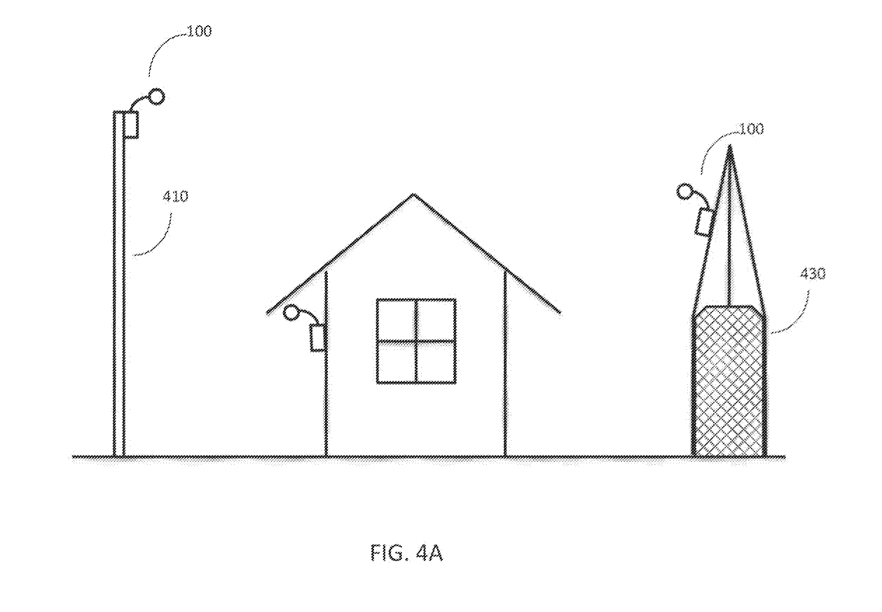

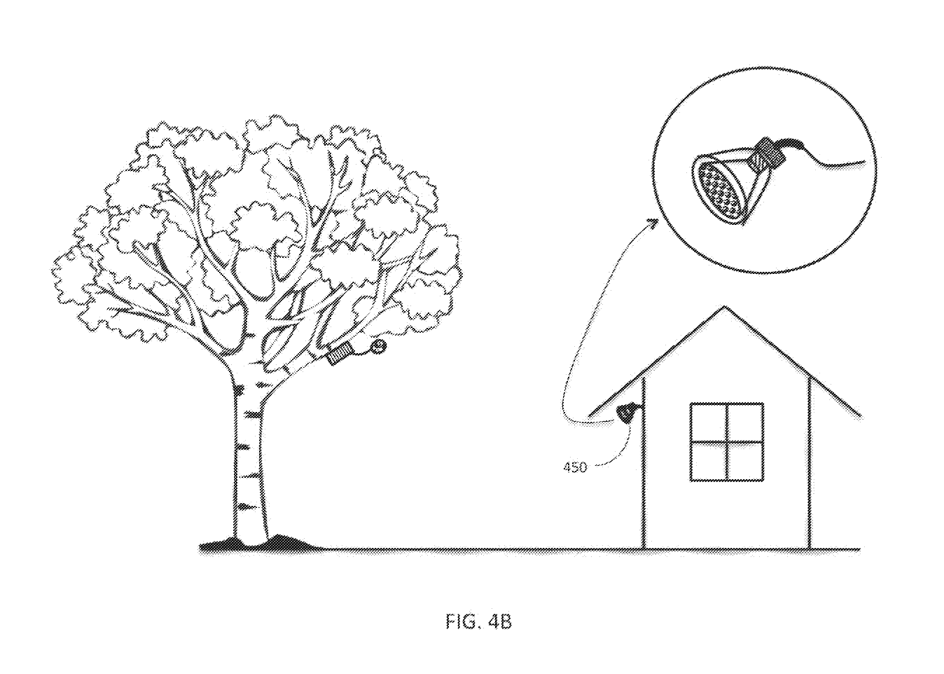

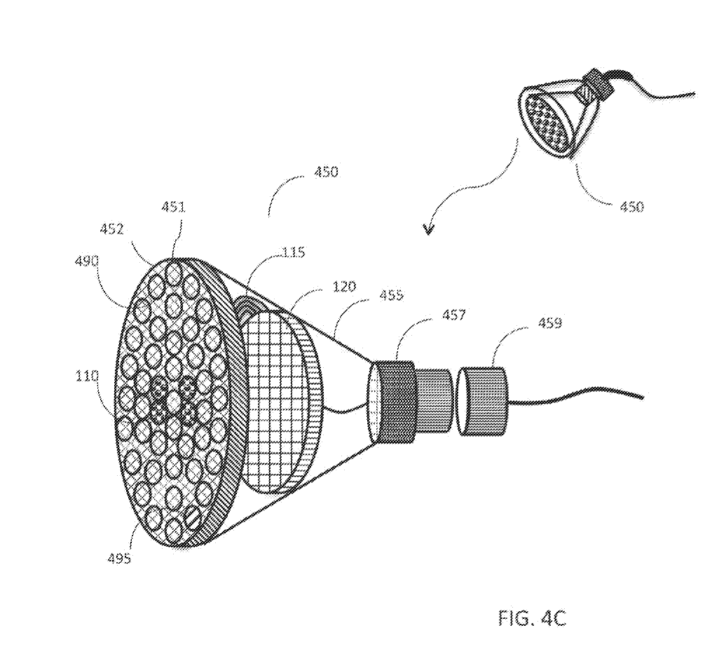

FIGS. 4A and 4B illustrate some applications of VM device 100. As shown in FIG. 4A, VM device 100 can be installed on a power pole 410 that is set up during the construction of a structure 420, or on or in the structure 420 itself. It can also be installed on or even integrated with a portable utility (e.g., a port-a-potty with integrated temporary power pole) 430. In one embodiment, the port-a-potty also serves as a support structure for power wires that provide temporary power for the construction of the structure. As shown in FIG. 4A, VM device 100 includes one or more eyestalks that can be adjusted to position the camera(s) 110 to capture desired images or videos of structure and/or some of its surroundings. As shown in FIG. 4B, VM device 100 can also be installed on a natural structure such as a tree. Further, as shown in FIGS. 4B and 4C, VM device 100 can also be configured as a bulb replacement 450 and attached to a lamp or light fixture.

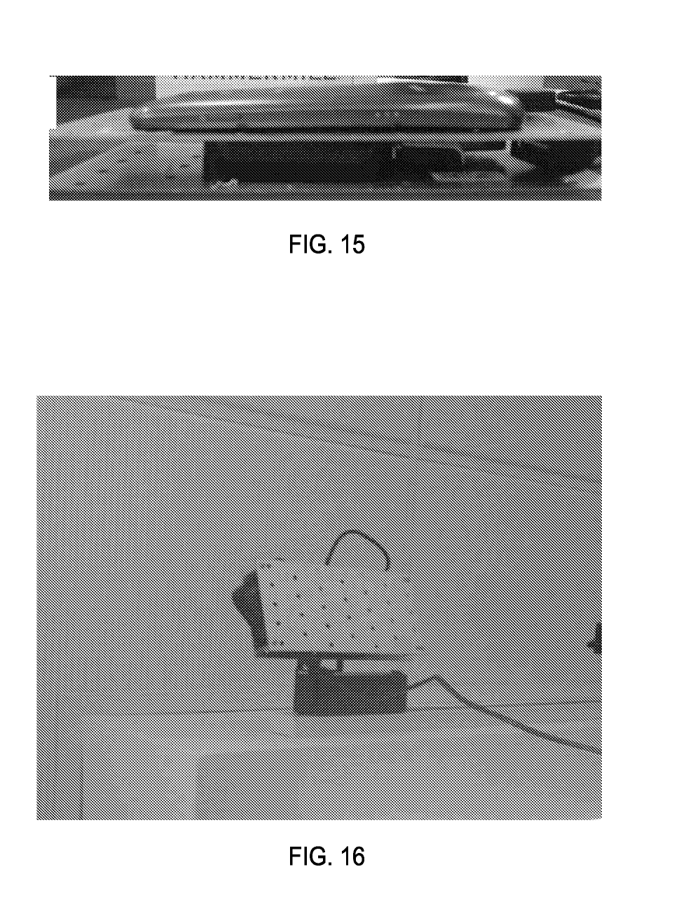

More specifically, some VM devices 100 can be configured to be attached to track-lighting fixtures, as depicted in FIGS. 15 and 16. Advantageously, the track-lighting fixtures can provide an already installed power source in locations that are good for a VM device 100. Thus, a system of VM devices 100 can be installed at a venue with minimal setup and overhead positions for camera placement. In some embodiments, the VM device 100 can include a transformer module to convert a power source in the tracklighting fixture to a form appropriate for the VM device (such as by changing the voltage or changing between direct current and alternating current). Further, in some embodiments the VM device 100 can include a wireless router (as best shown in FIG. 15A). Placing wireless routers at a tracklighting fixture can advantageously be in an elevated position and thus provide a broader physical range of wireless connectivity. As also shown, the VM device 100 can include heat sinks such as large metal plates to dissipate heat generated by the VM device 100 and any transformer modules included.

When VM device 100 is configured as a bulb replacement 450, the cameras 110 can be placed by themselves or among light emitting elements 451, such as LED light bulbs, behind a transparent face 452 of the bulb replacement. The mobile chipset 120 can be disposed inside a housing 455 of the bulb replacement, and a power adaptor 457 is provided near the base of the bulb replacement, which is configured to be physically and electrically connected to a base 459 of the lamp or light fixture, which is configured to receive a light bulb or tube that is incandescent, fluorescent, halogen, LED, Airfield Lighting, high intensity discharge (HID), etc., in either a screw-in or plug in manner, or the like. A timer or a motion sensor (such as an infrared motion sensor) 495 can also be provided to control the switching on and off of the light emitting elements. There can also be a mechanism (not shown) for some portion of the light bulb to rotate while the base of the bulb stays stationary to allow the cameras to be properly oriented.

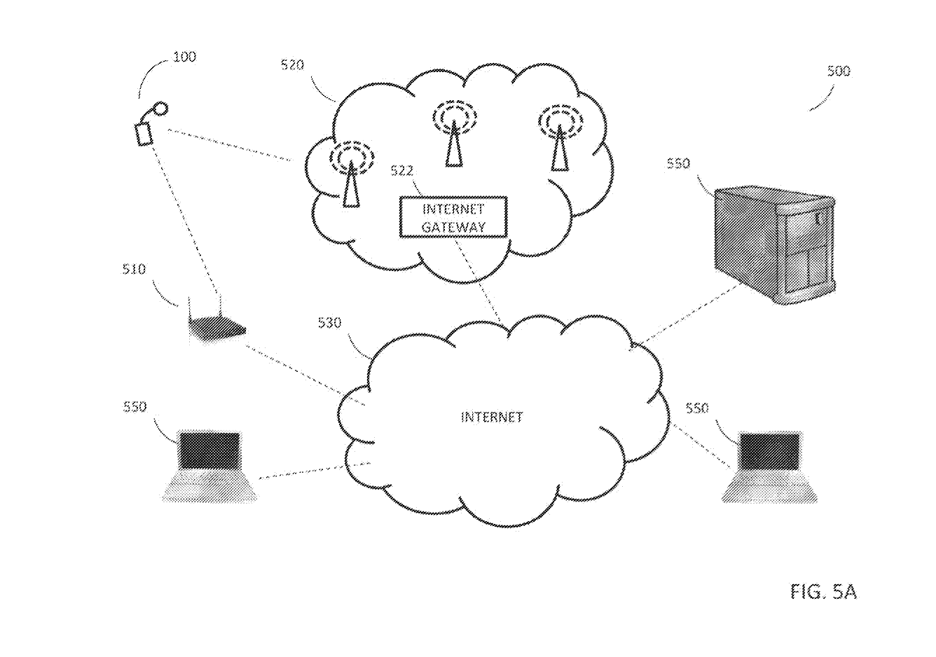

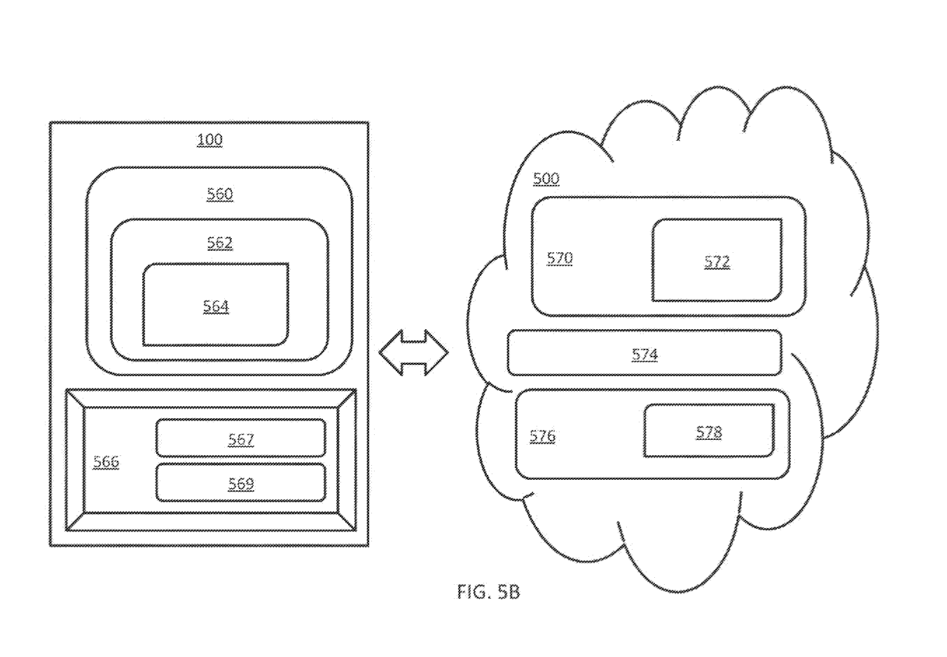

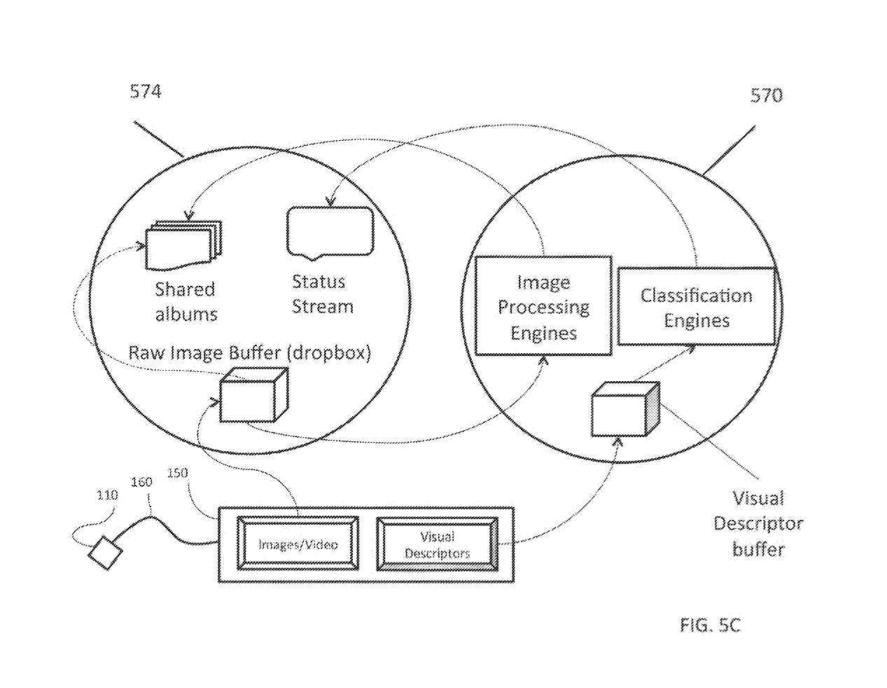

As shown in FIG. 5A, VM device 100 includes WiFi and/or cellular connections to allow it to be connected to a packet-based network 500 (referred sometimes herein as “the cloud”). In some embodiments, the packet-based network can include a WiFi hotspot 510 (if one is available), part or all of a cellular network 520, the Internet 530, and computers and servers 550 coupled to the Internet. When a WiFi hotspot is available, VM device 100 can connect to the Internet via the WiFi hotspot 510 using its built-in WiFi connection. VM device 100 can also communicate with the cellular network 520 using its built-in cellular connection and communicate with the Internet via an Internet Gateway 522 of the cellular network. The VM device might also communicate with the cloud 100 using wired Ethernet and optionally Power over Ethernet (PoE) (not shown). By connecting to the various modules described herein, a visual monitoring system including one or more VM devices 100 and one or more information devices can be combined into a visual monitoring system where the individual devices communicate with a server (composed of one or more devices) at the same location, a separate location, or both.

FIG. 5B illustrates a software architecture associated with VM device 100 according to embodiments. As shown in FIG. 5B, VM device 100 is installed with a mobile operating system 560 (such as the Android Operating System or any other operating system configured to be used in mobile devices such as smartphones and PDA's), and one or more camera application programs or “apps” (Camera App) 562 built upon the mobile operating system. The Camera App 562 can be a standalone program or a software platform that serves as a foundation or base for various feature descriptors and trigger specific script programs. When multiple eyestalks are used, VM device 100 further includes functions provided by a chip (e.g. FPGA, ASIC) 566, such as image multiplexing functions 567 and certain image processing functions such as feature/visual descriptor specific acceleration calculations (hardware acceleration) 569. Hardware acceleration can also be used for offloading a motion detection feature from the Camera App.

In some embodiments, the mobile operating system is configured to boot up in response to the VM device being connected to an external AC or DC power source (even though the VM device 100 includes a battery). In some embodiments, the VM device is configured to launch the Camera App automatically in response to the mobile operating system having completed its boot-up process. In addition, there can be a remote administration program so that the camera can be diagnosed and repaired remotely. This can be done by communicating to this administration program through the firewall via for example email, SMS, contacts, c2dm and sending shell scripts or individual commands that can be executed by the camera at any layer of the operation system (e.g., either at the Linux layer and/or the Android layer). Once the scripts or commands are executed, the log file is sent back via email or SMS. There can be some sort of authentication to prevent hacking of the VM device via shell scripts.

In some embodiments, the VM device 100 communicates with servers 550 coupled to a packet-based network 500, which can include one or more of software engines, such as an image processing and classification engine 570, a video stream storage and server engine 574, and an action engine 576. The image processing and classification engine 570 (built, for example, on Amazon's Elastic Computing Cloud or EC2e) can further include one or more classifier specific script processors 572. The image processing and classification engine 570 can include programs that provide recognition of features in the images captured by the VM device 100 and uploaded to the packet-based network 500. The action engine 576 (such as the one on Amazon's EC2) can include one or more action specific script processors 578. The video stream storage and server engine 574 can also be used to process and enhance images from the IP camera using, for example, multi-frame High Dynamic Range, multi-frame Low Light enhancement, multi-frame super-resolution algorithms or techniques.

As shown in FIG. 5C, still images and/or videos uploaded from the VM device are first stored in a raw image buffer associated with the video stream storage and server engine 574 (such as Google+), which hosts one or more social networks, and then transmitted to image processing engines 570, which processes the images/videos and transmit the processed images/videos to shared albums associated with the video stream storage and server engine 574. Another possible configuration is for the VM device 100 to upload video directly to the Image Processing and Classification Engines 570 on EC2 which then processes the data and send it to the Video Stream Storage server 574 on Google+(not shown).

As also shown in FIG. 5C, images and data for visual descriptor calculations are uploaded from the VM device 100 to a visual descriptor buffer 571 associated with the image processing and classification engines 570. Classification engines in the image processing and classification engines 570 perform visual descriptor classification on visual descriptors from the visual descriptor buffer and transfer the resulting classification information to a status stream folder associated with the video stream storage and server engine.

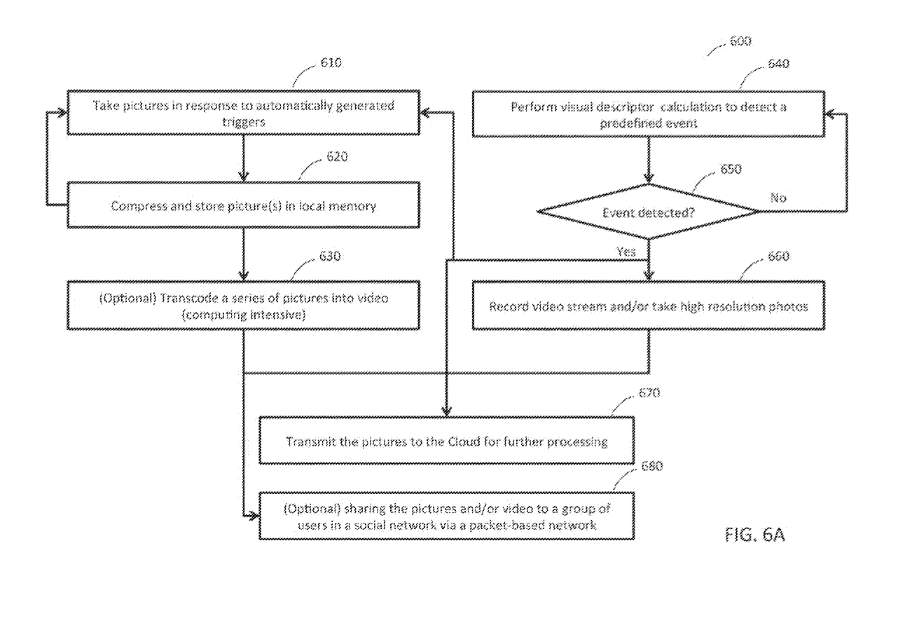

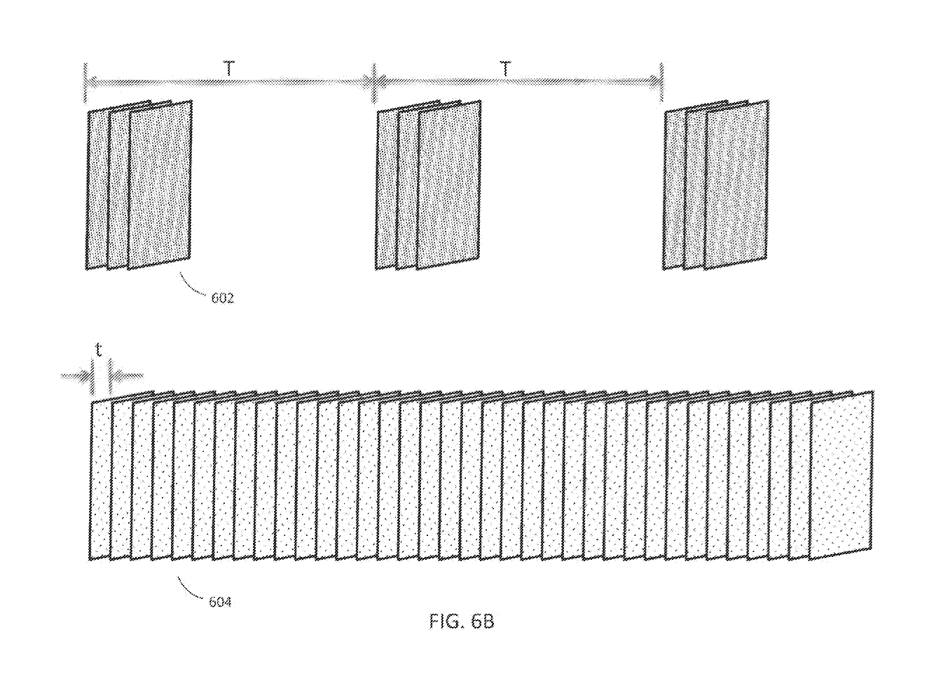

FIG. 6A illustrates a method 600 performed by VM device 100, when the Camera App and/or one or more application program built upon the Camera App are executed by the apps processor, to capture, process, and upload images/videos according to embodiments. As shown in FIGS. 6A and 6B, VM device 100 is configured to take pictures 602 in response to automatically generated triggers (610). In one embodiment, the triggers come from an internal timer in the VM device, meaning that VM device 100 takes one or a set of relatively high resolution pictures for each of a series of heart-beat time intervals T (e.g., 5 sec). In other embodiments, the triggers are generated by one or more application programs within or associated with the Camera App as a result of analyzing preview images 604 acquired by the camera(s) 110. In either case, the triggers are automatically generated requiring no human handling of the VM device 100. In some embodiments, the pictures are compressed and stored in local memory (620), such as the flash memory or removable memory and can optionally be transcoded into video before being uploaded (630). The pictures are uploaded (670) to one or more servers 650 in the cloud 500 for further processing. In some embodiments, the pictures are selected so that a picture is uploaded (670) only when it is significantly different from a predetermined number of prior pictures.

VM device 100 is also configured to perform visual descriptor and classification calculation (640) using, for example, low resolution preview images 604 from the camera(s), which are refreshed at a much more frequent pace (e.g. one image within each time interval t, where t<<T), as shown in FIG. 6B. In some embodiments, t can be in the order of microseconds (e.g., t=50 microseconds). The relatively low-resolution images are analyzed by VM device 100 to detect an interested event (such as a person entering or exiting a premise, or a significant change between two or more images) (640). Upon detection of such event (650), VM device 100 can be configured to record a video stream or perform computation for resolution enhancement of the acquired images (660).

In some embodiments, VM device 100 is further configured to determine whether to upload stored high resolution pictures based on certain criteria, which can include whether there is sufficient bandwidth available for the uploading (see below), whether a predetermined number of pictures have been captured and/or stored, whether an interested event has been detected, etc. If VM device 100 determines that the criteria are met, e.g., that bandwidth and power are available, that a predetermined number of pictures have been captured, that a predetermined time has passed since last uploading, and/or that an interested event has been recently detected, VM device 100 can upload the pictures or transcode/compress pictures taken over a series of time intervals T into a video using inter-frame compression and upload the video to the packet based network. In some embodiments, the high-resolution pictures are compressed and uploaded without being stored in local memory and transcoded into video previously. In some embodiments, the camera is associated with a user account in a social network service and uploads the videos or pictures to the packet based network together with one or more identifiers that identify the user account in the social network service, so that the pictures or videos are automatically shared among interested parties or stakeholders that were given permission to view the video through the social network service once they are uploaded (680).

In some embodiments, upon detection of an interested event, a trigger is generated to cause the VM device to take one or a set of pictures and upload the picture(s) to the packet-based network. In some embodiments, the VM device 100 can alternatively or additionally switch on a video mode and start to record video stream and/or take high resolution pictures at a much higher pace than the heartbeat pictures. The video stream and/or high resolution high frequency pictures are uploaded to the packet-based network as quickly as bandwidth allows to allow quick viewing of the interested event by users. In some embodiments, the camera uploads the videos or pictures to the packet-based network together with one or more identifiers that identify the user account in the social network service so the pictures are automatically shared among a predefined group of users of the social network service.

The VM device 100 can be further configured to record diagnostic information and send the diagnostic information to the packet-based network on a periodic basis.

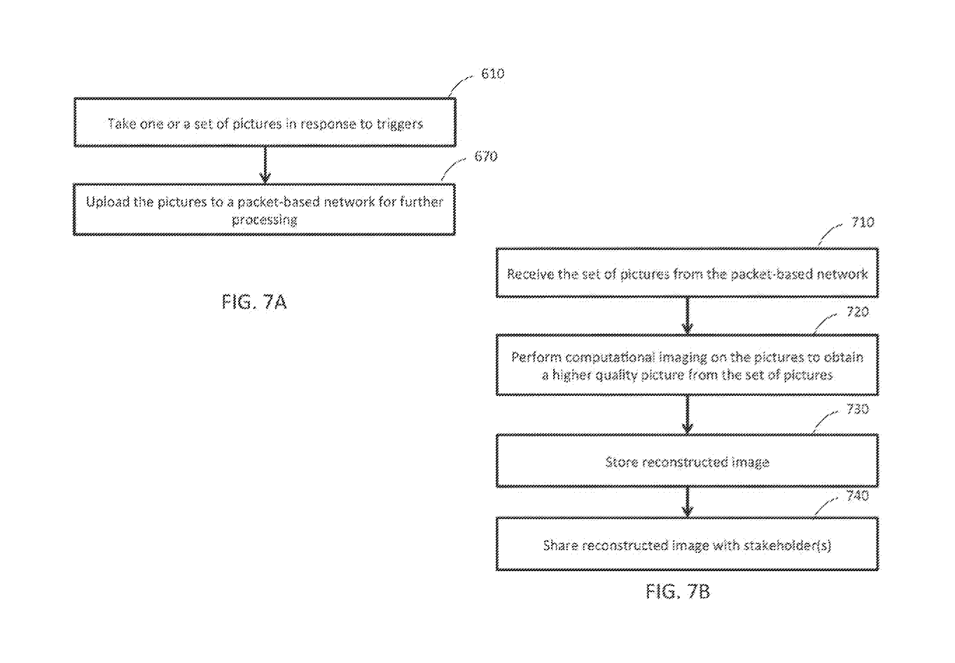

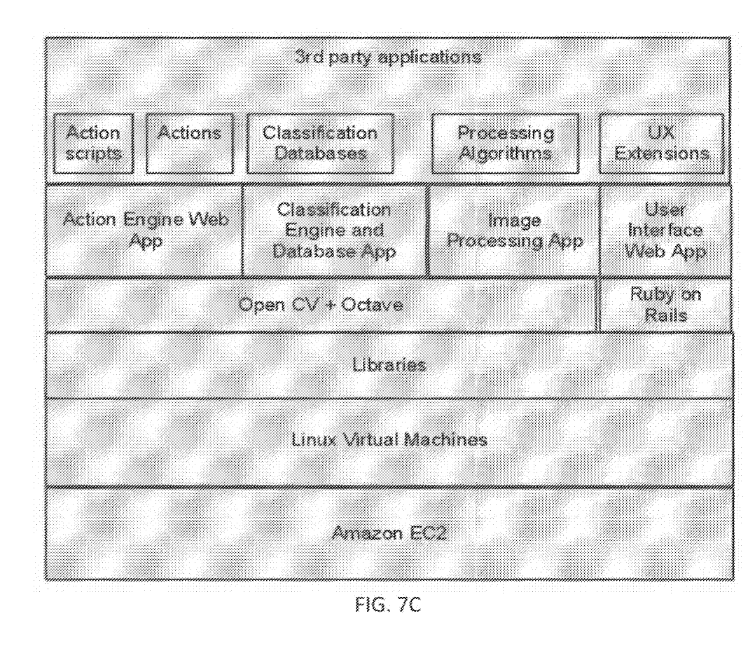

As shown in FIG. 7A, the VM device 100 takes one or a set of pictures in response to each trigger (610). The set of pictures are taken within very short time, which can be the shortest time the VM device can take the set of pictures. The set of pictures can be taken by one or multiple cameras that are placed closely together, and are used for multi-frame/multi-eyestalks high dynamic range (HDR), low-light or super resolution calculation performed at the VM device or in the servers.

As shown in FIGS. 7A and 7B, when the HDR or super resolution calculation is performed in the cloud 500, the set of pictures taken by the VM device in response to each trigger are uploaded (670) to the packet-based network for further processing. A server receiving the set of pictures (710) performs computational imaging on the pictures to obtain a higher quality picture from the set of pictures (720). The higher quality picture is stored (730) and/or shared (740) with a group of members of a social network, the members being associated with respective ones of a group of people or entities (e.g., stakeholders of a project being monitors), who have been given permission to view the pictures.

The server can also perform computer vision computations to derive data or information from the pictures, and share the data or information, instead of pictures, with the one or more interested parties by email or posting on a social network account.

FIG. 7C is a block diagram of a software stack at the server that performs the method shown in FIG. 7B and discussed in the above paragraphs. The server is based in the cloud (e.g. Amazon EC2). One or more virtual machines are run in the cloud using an operating system (e.g., Linux). These virtual machines can have many libraries on them, and in particular, libraries like Open CV and Rails. Open CV can be used to do image processing and computer vision functions. Rails can be used to build interactive websites. Other programs (e.g., Octave) can be run to do image processing and computer vision functions. Ruby can be used on Rails to build websites. The Action Engine web app function can be built on the aforementioned software stack to conduct specific actions when triggered by an event. For instance, in an application of using the VM device to monitor a parking lot, if a parking spot being monitored becomes available, the action engine can notify a mobile device of the driver of a car nearby who is looking for a parking spot. These actions can be added with action scripts (e.g. when parking spot is available, notify driver), and actions (e.g. send message to driver's smartphone) via APIs. One sensor platform can watch to see how many vehicles are entering a street segment and another sensor platform can watch to see how many cars are leaving a street segment. Often these sensor platforms will be placed on corners for greatest efficiency. All the entries and exits of a street segment need to be monitored by the sensor platforms to track to see how many vehicles are in a street segment. Also, signatures of the vehicles can be generated using visual descriptors to identify which vehicles have parked in a street segment vs. passed through a street segment. Using this method, the system can tell how many vehicles are parked in a street segment. This information can be used to increase the parking enforcement efficiency because segments with over parked vehicles are easily identified and/or helping drivers identify areas where there is parking available. The Classification engine and database app can try to match visual descriptors sent to the server by the camera to identify the object or situation in the database. Classification databases (e.g. visual descriptors for different cars) can be added via APIs for specific applications. The Image Processing App can process images (e.g. create HDR or super-resolution images). Additional processing algorithms can be added via APIs. There can also be a web app that can provide a GUI for users to control the camera via the web browser. This GUI can be extended by third-parties via APIs.

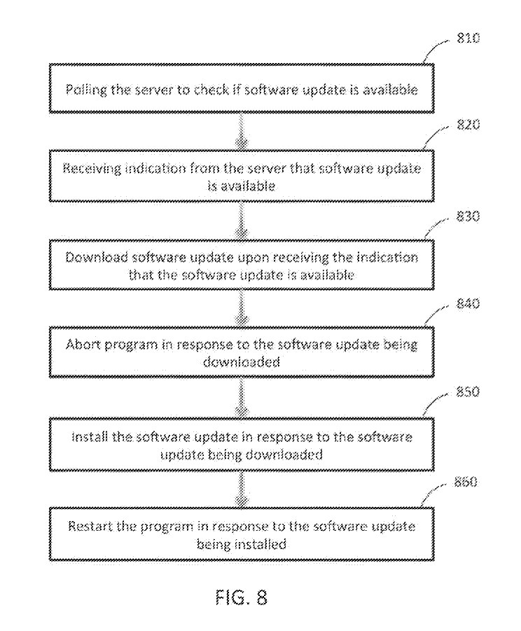

In some embodiments, the VM device 100 is also loaded with a software update program to update the Camera App 562 and/or associated application programs 564. FIG. 8 is a flowchart illustrating a process performed by the VM device 100 when the software update program is being executed by the apps processor. As shown in FIG. 8, the VM device 100 polls (810) a server storing software for the VM device 100 to check if software update is available. When the VM device 100 receives (820) indication from the server that software updates are available, it downloads (830) software updates. In response to the software updates being downloaded, the VM device 100 would abort (840) the visual monitoring program discussed above so as to install (850) the software update. The VM device 100 would restart the program (860) in response to the software update being installed. In one embodiment, all of the steps illustrated in FIG. 8 are performed automatically by the VM device 100 without user intervention.

In some embodiments, the VM device 100 is also loaded with a WiFi hookup assistance program to allow a remote user to connect the VM device to a nearby WiFi hotspot via the packet-based network. FIG. 9 is a flowchart illustrating a process performed by the VM device when the WiFi hookup assistance program is being executed by the apps processor. As shown in FIG. 9, the VM device 100 would observe (910) availability of WiFi networks, inform (920) a server it is communicating with about the availability of the WiFi networks, and receive set up information for a WiFi network. The VM device 100 would then attempt WiFi hook-up (940) using the set-up information it received, and transmit (950) any diagnostic information to the cloud 500 to inform the server whether the hook-up has been successful. Upon successful hook-up to the WiFi network, the VM device 100 would stop (960) using the cellular connection and start using the WiFi connection to upload (970) pictures or data associated with the pictures it takes.

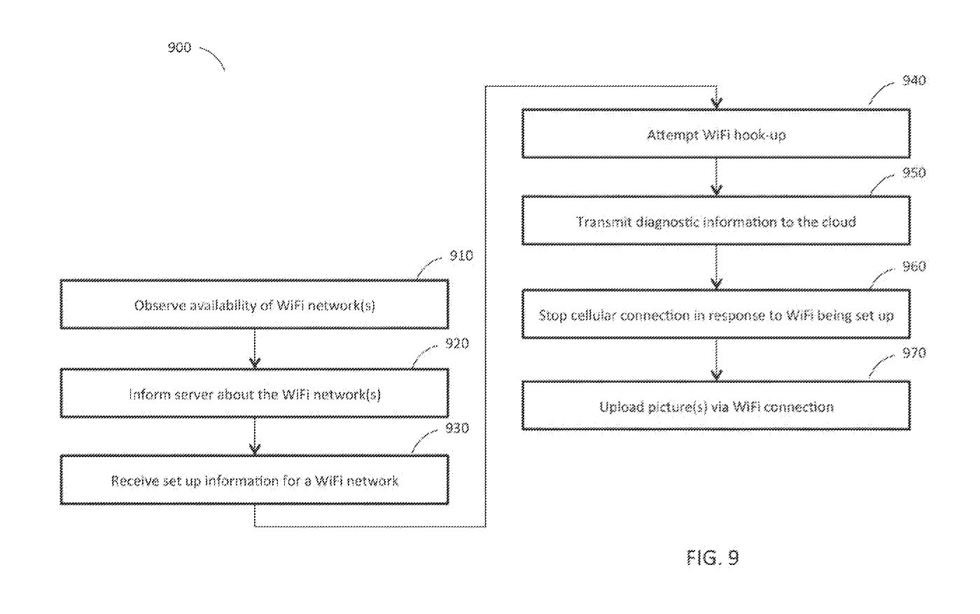

In some embodiments, the VM device 100 is also loaded with a hotspot service program to allow the VM device to be used as a WiFi hotspot so that nearby computers can use the VM device as a hotspot to connect to the packet-based network. FIG. 10 is a flowchart illustrating a process performed by the VM device when the hotspot service program is being executed by the apps processor. As shown in FIG. 10, while the VM device 100 is taking (1010) pictures/videos in response to triggers/events, it would observe (1020) any demand for use of the VM device 100 as a WiFi hotspot and perform (1030) hotspot service. While it is performing the hotspot service, the VM device 100 would observe (1040) bandwidth usage from the hotspot service, and either buffer (1050) the pictures/videos when the hotspot usage is high, or upload (1060) the pictures/videos to the cloud 500 for further processing or sharing with a group of users of a social network when the hotspot usage is low.

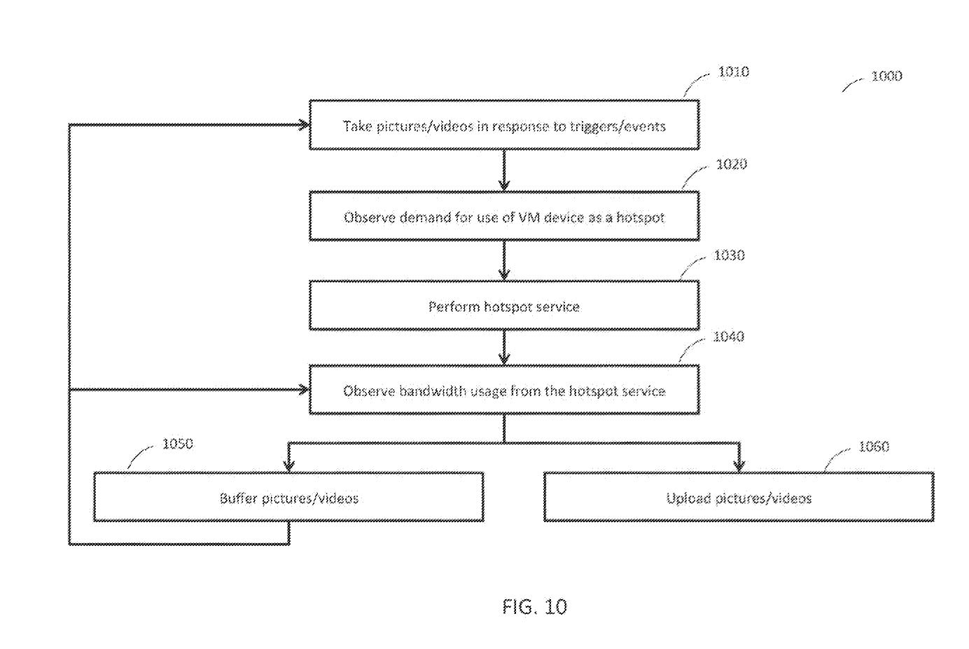

FIG. 11 is a block diagram illustrating a software stack 1100 associated with the VM device 100. As shown in FIG. 11, the Camera App 562 according to one embodiment can be implemented as part of an applications layer 1110 over a mobile operating system 560 (e.g., the Android Operating System having an application framework layer 1120 over a libraries layer 1130), which is built over a base operating system (e.g., Linux having a services layer 1140 over a kernel layer 1150). The applications layer 1102 can include other applications such as an administrator application 1101 for administrating the Camera App and a watchdog application 1102 for monitoring the Camera app. The applications layer can also include applications such as Java mail 1103, which is used by the Camera App to send/receive email messages, FFMEG 1104, which can be used by the Camera App to optionally transcode, for example individual JPG image files, into, for example, an inter-frame H.264 video file that has 10× high compression, and/or OpenCV 1105, which is used by the Camera App to perform image processing and other computer vision tasks like finding and calculating visual descriptors. The applications layer can include well-known applications such as Contacts 1106 for recording contacts information, instant messaging, and/or short messaging service (SMS) 1107, which the Camera App utilizes to perform the functions of the VM devices discussed herein.

The Linux kernel layer 1150 includes a camera driver 1151, a display driver 1152, a power management driver 1153, a WiFi driver 1154, and so on. The service layer 1140 includes service functions such as an init function 1141, which is used to boot up operating systems and programs. In one embodiment, the init function 1141 is configured to boot up the operating systems and the Camera App in response to the VM device 100 being connected to external power instead of pausing at battery charging. It is also configured to set up permissions of file directories in one or more of the memories in the VM device 100.

In one embodiment, the camera driver 1151 is configured to control exposure of the camera(s) to: (1) build multi-frame HDR pictures, (2) focus to build focal stacks or sweep, (3) perform scalado functionalities (e.g., speedtags), and/or (4) allow the FPGA to control multiple cameras and perform hardware acceleration of triggers and visual descriptor calculations. In one embodiment, the display driver 1152 is configured to control backlight to save power when the display/input module 130 is not used. In one embodiment, the power management driver is modified to control charging of the battery to work with solar charging system provided by one or more solar stalks.

In one embodiment, the WiFi driver 1154 is configured to control the setup of WiFi via the packet-based network so that WiFi connection of the VM device can be set up using its cellular connections, as discussed above with reference to FIG. 9, eliminating the need for a display module on the VM device.

Still referring to FIG. 11, the mobile operating system includes a libraries layer 1130 and an application framework layer 1120. The libraries layer includes a plurality of runtime libraries such as OpenGL|ES 1131, Media Framework 1132, SSL 1133, libc 1134, SQLite 1135, Surface Manager 1136, etc. The OpenGL|ES 1131 is used by the Camera App 562 to accelerate via GPU offload calculations like motion detection calculations, visual descriptor calculations (such as those for finding interested feature points in captured images or videos), calculations related to image processing algorithms such as HDR fusion and low light boosting, etc. The media framework 1132 is used by the Camera App 562 to compress pictures and videos for storage or uploading. The SSL 1133 is used by the Camera App 562 to authenticate via certain protocols (e.g., OAuth) to authenticate access to the social network and/or on-line storage accounts (such as Google+ or Picassa) and to set up HTTP transport. The SQLite 1135 is used by users or administrators of the VM device to remotely control the operation of the Camera App 562 and/or the VM device 100 by setting up and/or updating certain on-line information associated with an on-line user account (e.g., gmail contacts). Such on-line information can be synced with the contacts information on the VM device which is used by the Camera App to set up parameters that determine how the Camera App runs and what functions it performs. This manner of controlling the VM device allows the user to bypass the firewalls of the mobile operating system. Other such ways of controlling the VM device through the firewall include, emails, chat programs, Google's Cloud to Device Messaging, and SMS messages. The Surface Manager is used by the Camera App to capture preview pictures from the camera(s), which can be used for motion detection and/or other visual descriptor calculation at a much higher frame rate than using pictures or videos to do the calculation.

Still referring to FIG. 11, the application framework layer 1120 includes an activity manager 1121, content providers 1122, a view system 1123, a location manager 1124 and a package manager 1125. The location manager 1124 can be used to track the VM device if it is stolen or lost or simply to add geolocation information to pictures/video. The package manager 1125 can be used to control updates and start/stop times for the Camera App.

Still referring to FIG. 11, in the applications layer, a watchdog program 1102 is provided to monitor the operation of the VM device 100. The watchdog 1102 can be configured to monitor the operating system and in response to the operating system being booted up, launch the Camera App. The watchdog program notes when: (1) the VM device 100 has just been connected to external power; (2) the VM device 100 has just been disconnected from external power; (3) the VM device 100 has just booted up; (4) the Camera App is forced stopped; (5) the Camera App is updated; (6) the Camera App is force updated; (7) the Camera App has just started, and/or (8) other events occurs at the VM device 100. The watchdog can send notices to designated user(s) in the form of, for example, email messages, when any or each of these events occurs.

Also in the applications layer, an administrator program 1101 is provided to allow performance administrative functions such as shutting down the VM device 100, rebooting the VM device 100, stopping the Camera App, restarting the Camera App, etc. remotely via the packet-based network. In one embodiment, to bypass the firewalls, such administrative functions are performed by using the SMS application program or any of the other messaging programs provided in the applications layer or other layers of the software stack.

Still referring to FIG. 11, the software stack can further include various trigger generating and/or visual descriptor programs 564 built upon the Camera App 560. A trigger generating program is configured to generate triggers in response to certain predefined criteria being met and prescribe actions to be taken by the Camera App in response to the triggers. A visual descriptor program is configured to analyze acquired images (e.g., preview images) to detect certain prescribed events and notifies the Camera App when such events occurs and/or prescribe actions to be taken by the Camera App in response to the events. The software stack can also include other application programs 564 built upon the Camera App 560, such as the moving object counting program discussed below.

The Camera App 560 can include a plurality of modules, such as an interface module, a settings module, a camera service module, a transcode service module, a pre-upload data processing module, an upload service module, an (optional) action service module, an (optional) motion detection module, an optional trigger/action module and an (optional) visual descriptor module.

Upon being launched by, for example, the watchdog program 1102 upon boot-up of the mobile operating system 560, the interface module performs initialization operations including setting up parameters for the Camera App based on settings managed by the settings module. As discussed above, the settings can be stored in the Contacts program and can be set-up/updated remotely via the packet-based network. Once the initialization operations are completed, camera service module starts to take pictures in response to certain predefined triggers, which can be, triggers generated by the trigger/action module in response to events generated from the visual descriptor module or certain predefined triggers, such as, for example, the beginning or ending of a series of time intervals according an internal timer. The motion sensor module can start to detect motions using the preview pictures. Upon detection of certain motions, the interface module would prompt the camera service module to record videos or take high-definition pictures or sets of pictures for resolution enhancement or HDR calculation, or the action service module to take certain prescribed actions. It can also prompt the upload module to upload pictures of videos associated with the motion event.

Without any motion or other visual descriptor events, the interface module can decide whether certain criteria are met for pictures or videos to be uploaded (as described above) and can prompt the upload service module to upload the pictures or videos, or the transcode service module to transcode a series of images into one or more videos and upload the videos. Before uploading, the pre-upload data processing module can process the image data to extract selected data of interest, group the data of interest into a combined image, such as the tripline images discussed below with respect to an object counting method. The pre-upload data processing module can also compress and/or transcode the images before uploading.

The interface module is also configured to respond to one or more trigger generating programs and/or visual descriptor programs built upon the Camera App, and prompt other modules to act accordingly, as discussed above. The selection of which trigger or events to respond to can be prescribed using the settings of the parameters associated with the Camera App, as discussed above.

As one application of the VM device, the VM device can be used to visually datalog information from gauges or meters remotely. The camera can take periodic pictures of the gauge or gauges, convert the gauge picture using computer vision into digital information, and then send the information to a desired recipient (e.g. a designated server). The server can then use the information per the designated action scripts (e.g. send an email out when gauge reads empty).

As another application of the VM device 100, the VM device 100 can be used to visually monitor a construction project or any visually recognizable development that takes a relatively long time to complete. The camera can take periodic pictures of the developed object, and send images of the object to a desired recipient (e.g. a designated server). The server can then compile the pictures into a time-lapsed video, allowing interested parties to view the development of the project quickly and/or remotely.

As another application of the VM device 100, the VM device 100 can be used in connection with a tripline method to count moving objects. In one embodiment, as shown in FIG. 1E and FIG. 5, the VM device 100 comprises a modified android smartphone 180 with a camera 110 on a tether, and a server 550 in the cloud 500 is connected to the smartphone 180 via the Internet 530. The camera can be mounted on the inside window of a storefront with the smartphone mounted on the wall by the window. This makes for a very small footprint since only the camera is visible through the window from outside the storefront.

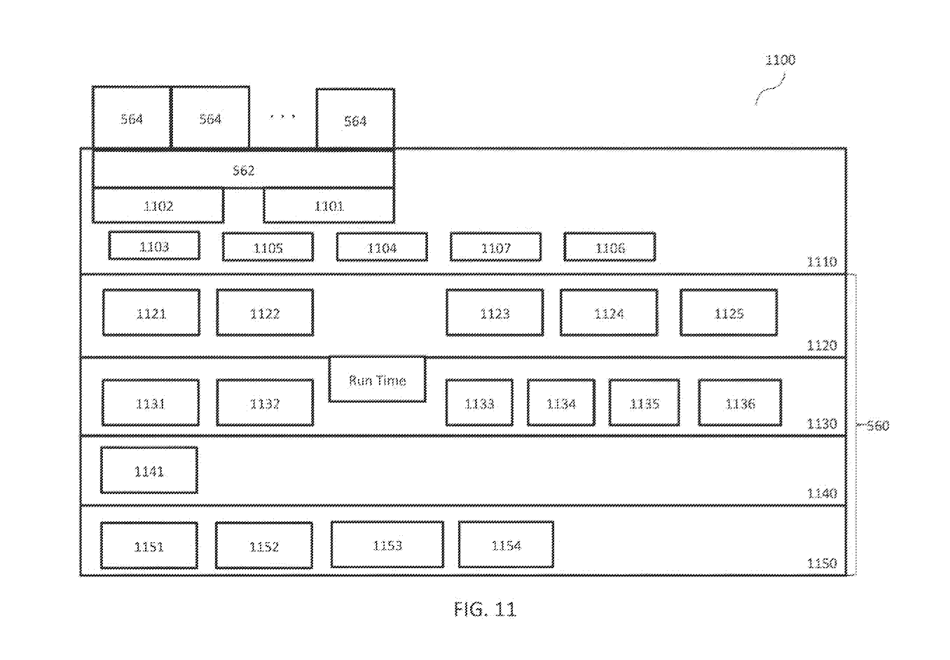

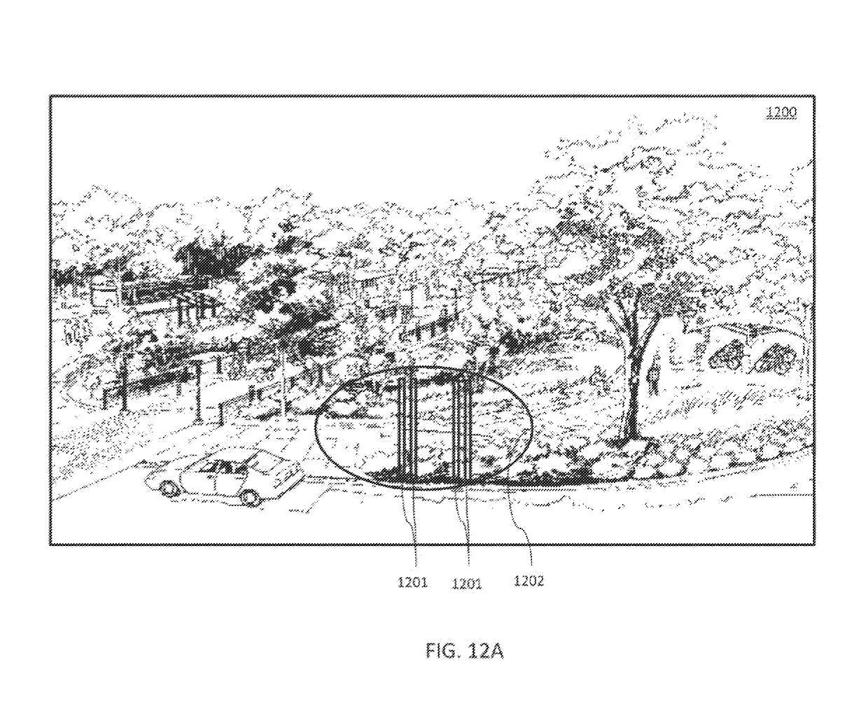

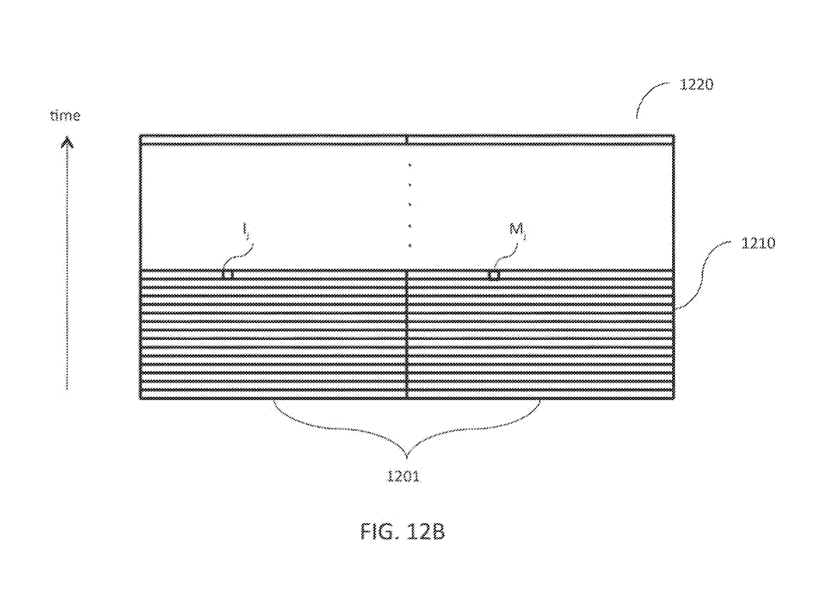

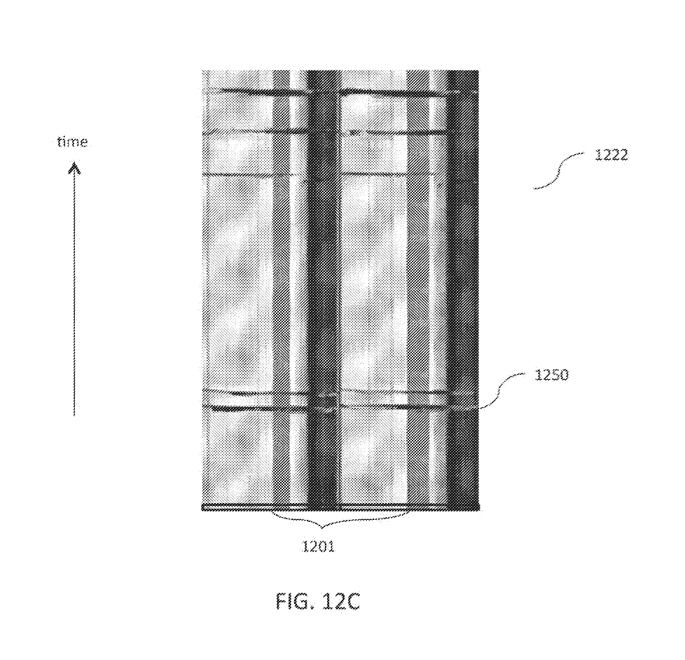

As shown in FIG. 12A, in a camera's view 1200, one or more line segments 1201 for each region of interest 1202 can be defined. Each of these line segments 1201 is called a Tripline. Triplines can be set up in pairs. For example, FIG. 12A shows two pairs of triplines. On each frame callback, as shown in FIG. 12B, the VM device 100 stacks all the pixels that lie on each of a set of one or more Triplines, and joins all these pixel line segments into a single pixel row/line 1210. For example, in FIG. 12B, pixels from a pair of triplines at each frame call back are placed in a horizontal line. Once the VM device 100 has accumulated a set number of lines 1210 (usually 1024 lines), these lines now form a 2 dimensional array 1220 of YUV pixel values. This 2 dimensional array is equivalent to an image (Tripline image) 1220. This image 1220 can be saved to the SD card of the smartphone and then compressed and sent to the server by the upload module of the Camera App 560. The outcome image has the size of Wx1024, where W is the total number of pixels of all the triplines in the image. The height of the image can represent time (1024 lines is approximately 1 minute). A sample tripline 1222 image is shown in FIG. 12C. The image 1222 comprises pixels of two triplines of a side walk region in a store front, showing 5 pedestrians crossing the triplines at different times. Each region usually has at least 2 triplines to calculate direction and speed of detected objects. This is done by measuring how long it takes for the pedestrian to walk from one tripline to a next one. The distance between triplines can be measured beforehand.

The server 550 processes each tripline image independently. It detects foregrounds and returns the starting position and the width of each foreground region. Because the VM device 100 automatically adjusts its contrast and focus, intermittent lighting changes occur in the tripline image. To deal with this problem in foreground detection, an MTM (Matching by Tone Mapping) algorithm is used as at first to detect the foreground region. In one embodiment, the MTM algorithm comprises the following steps: Breaking tripline segment; K-Means background search; MTM background subtraction; Thresholding and event detection; and Classifying pedestrian group.

Because each tripline images can include images associated with multiple triplines, the tripline image 1220 is divided into corresponding triplines 1210 and MTM background subtraction is performed independently.

In the K-Means background search, because a majority of the triplines are background, and because background triplines are very similar to each other, k-means clustering is used to find the background. In one embodiment, grey-scale Euclidean distance as k-means distance function is used:

D=Σⱼ₌₀^{N}(Ij−Mj)²

where I and M are two triplines with N pixels. Ij and Mj are pixels at j position, as shown in FIG. 12B.

The K-means++ algorithm can be used to initialize k-means iteration. For example, K is chosen to be 5. In one embodiment, a tripline is first chosen from random as the first cluster centroid. Distances between other triplines and the chosen tripline are then calculated. The distances are used as weights to choose the rest of cluster centroids. The bigger the weight, the more likely it is to be chosen.

After initialization, k-means is run for a number of iterations, which should not exceed 50 iterations. A criteria, such as that a cluster assignment does not change for more than 3 iterations, can be set to end the iteration.

In one embodiment, each cluster is assigned a score. The score is a sum of inverse distance of all the triplines in the cluster. The cluster with the largest score is assumed to be the background cluster. In other words, the largest and tightest cluster is considered to be the background. Distances between other cluster centroids to the background cluster centroid are then calculated. If any of distances is smaller than 2 standard deviation of the background cluster, it is merged into the background. K-means is performed again with merged clusters.

MTM is a pattern matching algorithm proposed by Yacov Hel-Or et. al. It takes two pixel vectors and returns a distance that ranges from 0 to 1, where 0 means the two pixel vectors are not similar and 1 means the two pixel vectors are very similar. For each tripline, the closest background tripline (in time) from background cluster is found and a M™ distance between the two is afterward determined. In one embodiment, an adaptive threshold MTM distance is used. For example, if an image is dark, meaning the signal to noise ratio is high, then the threshold is high. If an image is indoors and has good lighting conditions, then the threshold is low. The MTM distance between neighboring background cluster triplines can be calculated, i.e. the MTM distance between two triplines that are in background cluster obtained from k-means and are closest to each other in time. The maximum of intra-background MTM distance is used as threshold. The threshold can be clipped, for example, between 0.2 and 0.85.

If MTM distance of a tripline is higher than the threshold, it is considered to belong to an object, and it is labeled with a value, e.g., “1”, to indicate that. A closing operator is then applied to close any holes. A group of connected 1's is called an event of the corresponding tripline.

In one embodiment, the triplines come in pairs, as shown in FIGS. 12a-12C. The pair of triplines are placed close enough so that if an object crosses one tripline, it should cross the other tripline as well. Pairing is a good way to eliminate false positives. Once all the events in the triplines are found, they are paired up, and orphans are discarded. In a simple pairing scheme, if one object cannot find a corresponding or overlapping object on the other tripline, it is an orphan.

The above described tripline method for object counting can be used to count vehicles as well as pedestrians. When counting cars, the triplines are defined in a street. Since cars move much faster, the regions corresponding to cars in the tripline images are smaller. In one embodiment, at 15-18 fps, the tripline method can achieve a pedestrian count accuracy of 85% outdoor and 90% indoor, a car count accuracy of 85%.

In one embodiment, the trip-line method can also be used to measure a dwell time, i.e. the duration of time in which a person dwells in front of a venue such as a storefront. Several successive triplines can be set up the images of a store front and the pedestrian velocity as they walk in front of the store front can be measured. The velocity measurements can then be used to get the dwell time of each pedestrian. The dwell time can be used as a measure of the engagement of a window display.

Alternatively, or additionally, the VM device 100 can be used to sniff local WiFi traffic and associated MAC addresses of local WiFi devices. In one embodiment, the VM device 100 can be used to sniff local WiFi traffic and/or associated MAC addresses of local WiFi devices. These MAC addresses are associated with people who are near the VM device 100, so the MAC addresses can be used for people counting because the number of unique MAC addresses at a given time can be an estimate of the number of people around with smartphones.

Since MAC addresses are unique to a device and thus unique to a person carrying the device, the MAC addresses can also be used to track return visitors. To preserve the privacy of smartphone carriers, the MAC addresses are never stored on any server. What can be stored instead is a one-way hash of the MAC address. From the hashed address, one cannot recover the original MAC address. When a MAC address is observed again, it can be matched with a previously recorded hash.

WiFi sniffing allows uniquely identifying a visitor by his/her MAC address (or hash of the MAC address). The camera can also record a photo of the visitor. Then, either by automatic or manual means, the photo can be labeled for gender, approximate age, and ethnicity. The MAC address can be tagged with the same labels. This labeling can be done just once for new MAC addresses so that this information can be gathered in a more scalable fashion since over a period of time, a large percentage of the MAC addresses will have demographics information attached. This allows using the MAC addresses to do counting and tracking by demographics. Another application is clienteling where the MAC address of a visitor gets associated to the visitors loyalty card or other identifying information. When the visitor nears and enters a venue, the venue staff knows that the visitor is in the venue and can better service the visitor appropriately by understanding their preferences, how important of a visitor they are to that venue, and whether they are a new vs. a repeat visitor.

In addition to the WiFi counting and tracking as described above, and audio signals can also be incorporated. For example, if the microphone hears the cash register, the associated MAC address (visitor) can be labeled with a purchase event. If the microphone hears a door chime, the associated MAC address (visitor) can be labeled with entering the venue. Similarly, if the VM device 100 is associated in a system with a cash register or other point of sale device, information about the specific purchase can be associated with the visitor.

For a VM device 100 mounted inside a store display, the number of people entering the venue can be counted by counting the number of times a door chime rings. The smartphone can use it's microphone to listen for the door chime, and report the door chime count to the server.

In one embodiment, a VM device mounted inside a store display can listen to the noise level inside the venue to get an estimate of the count of people inside the venue. The smartphone can average the noise level it senses inside the venue every second. If the average noise level increases at a later time, then the count of the people inside the venue most likely also increased, and vice versa.

For a sizable crowd such as a restaurant environment, the audio generated by the crowd is a very good indicator of how many people are present in the environment. If one were to plot the recording from a VM device disposed in a restaurant and the recording starts at 9:51 am, and ended at 12:06 pm. The plot should show that the volume goes up as the venue opens at 11 am, and continues to increase when the restaurant gets busier and busier towards lunchtime.

In one embodiment, background noise is filtered. Background noise can be any audio signal that is not generated by human, for example, background music in a restaurant is background noise. The audio signal is first transformed to the frequency domain, and then a band limiting filter can be applied between 300 Hz and 3400 Hz. The filtered signal is then transformed back to time domain and the audio volume intensity is then calculated.

Other sensing modalities that can be sensed are barometer (air pressure), accelerometer, magnetometer, compass, GPS, gyroscope. These sensors along with the sensors mentioned above can be fused together to increase the overall accuracy of the system. Sensing data from multiple sensor platforms in different locations can also be merged together to increase the overall accuracy of the system. In addition, once the data is in the cloud, the sensing data can be merged together with other 3rd party data like weather, Point-of-sales, reservations, events, transit schedules, etc. to generate prediction of the data and analytics. For example, pedestrian traffic is closely related to the weather. By using statistical analysis, the amount of pedestrian traffic can be predicted for a given location.

A more sophisticated prediction is for site selection for retailers. The basic process is to benchmark existing venues to understand what the traffic patterns look like outside an existing venue. Then correlate the Point of sales for that venue with the outside traffic. From this a traffic based revenue model can be generated. Using this model, prospective sites are measured for traffic and the likely revenue for a prospective site can be estimated. Sensor platforms deployed for prospective venues often do not have access to power or WiFi. In these cases, the android phones will be placed in exterior units so that they can be strapped to poles/trees or attached to the side of buildings temporarily. An extra battery will be attached to the phone instead of the enclosure so that the sensor platform can run entirely on battery. In addition, compressive sensing techniques will be used to also extend battery life. The cellular radio will be used in a non-continuous manner to also extend battery life of the platform.

Another use case is to measure the conversion rate of pedestrians walking by a store front vs. entering a venue. This can be done by having either two sensor platforms, one watching the street and another watching the door. Alternatively, a two-eye stalk sensor platform can be used to have one eye stalk camera watching the street and another watching the door. The two camera solution is preferred since the radio and computation can be shared among the two cameras. By recording when the external storefront changes (e.g. new posters in the windows, new banners), a comprehensive database of conversion rates can be compiled that allows predictions as to which type of marketing tool to use to improve conversion rates.

Another use case is to use the cameras on the sensor platform in an area where there are many sensor platforms are deployed. Instead of having out-of-date Google Streetview photos taken every 6-24 months, realtime streetview photos can be merged on existing Google Streetview photos to provide a more up-to-date visual representation of how a certain street appears at that moment.

In further embodiments, the VM devices 100 (or, similarly, systems of VM devices) can be configured to detect groups of visitors. For example, in some occasions a family will arrive at a venue, event center, or the like as a group. For some purposes, it might not be useful to consider every member of the group as a separate person, such as in a retail setting where purchases from more than one member of the group are unlikely. A frequent example of this is when one or more parents come to a grocery store with one or more children, as a family unit. In such situations, usually one set of purchases will ultimately be made by one member of the group. Further, the same purchases would likely be made if only one member of the group (e.g., a parent) came alone. Thus, it may be advantageous to identify the group as a single visitor group unit.

Single visitor group units can be identified in a number of ways. For example, in some embodiments image and video data from the cameras can be analyzed to identify people who move in groups. Multiple people who remain in close physical proximity or who make physical contact with each other can be identified as being in a single group (for example, using the average distance between members of the group or a number of detected touches between members of the group). Similarly, in embodiments where cameras view a parking lot or entrance, people who arrive in the same car or otherwise arrive at a venue at the same time can be identified as being in a single group.

In other embodiments, groups can be identified using wireless connectivity information. For example, people living in the same house, working at the same venue, or otherwise frequenting the same locations can carry smartphones or other WiFi enabled devices that are configured to connect to particular wireless networks. These devices, while in the venue, might beacon for the Service Set Identification (SSID) of the same wireless network or router. This information can also be used to identify a single group.

In some embodiments, the various methods for identifying groups can be combined. For example, in some embodiments each type of data can be combined and processed to produce a probability or score indicative of the likelihood that the visitors are part of a single group or visitor unit. If this probability or score exceeds a certain threshold, the system can identify them accordingly.

Further, in some embodiments the system can identify a type of group or visitor unit. For example, in some embodiments children can be identified, for example, by their size using visual data. Thus, a family visitor unit can be identified when one or more adults and one or more children are identified as a group. Further, in some embodiments the age of the children can be estimated according to their size. Even further, in some embodiments a parent in a family visitor unit can be identified by a larger size. Further, in some embodiments a group leader can be identified according to which member of the group ultimately makes a purchase. In other embodiments, groups or visitor units that consistently visit together can be identified as a family visitor unit. In other embodiments, people that visit together inconsistently can be identified as friend visitor units. As discussed herein, the VM devices 100 and systems associated with said devices can treat members of certain groups differently, for example by providing targeted advertisements directed toward such groups.

In some embodiments, the number of total visitors to a venue can be tracked. In further embodiments, the number of individual visitor units can be tracked. Even further, in some embodiments the number, size, and type of visitor units can be tracked.

Further, it will be understood that in some embodiments, substantially all visitors to a venue can be tracked (as described herein) automatically. In further embodiments, information regarding these visitors can be tracked and analyzed (as described herein) in real-time. In other embodiments, some or all of the data analysis may be done at a later time, particularly when no immediate action is desired from the systems described herein. In further embodiments 10 or more, 50 or more, or 100 or more visitors can be tracked simultaneously, in real-time.

In addition to identifying groups or visitor units, the VM device 100 and associated systems can be configured to identify individual people. As generally discussed above, individuals can be identified using visual data such as a picture or video. Further, individuals can be identified by a WiFi enabled device (for example, by the MAC address of the device). Even further, in some embodiments individuals can be identified by audio, using their voice. Even further, in some embodiments individuals can be identified using payment information such as their credit card number or the name associated with their credit card. In further embodiments, individuals can be identified by loyalty accounts or through other rewards programs. Notably, when sensitive data (such as credit card information) is stored in the system, it can be stored using a hash function to generate an associated hash value that can be used to identify the individual without storing sensitive data.

Further, in some embodiments the different methods to identify an individual can be combined. For example, an image of a person can be associated with a MAC address of a device they carry. In some embodiments, these can be combined by locating the position of an individual at a venue using their WiFi signal (for example, with triangulation). Multiple wireless antennas (such as directional wireless antennas) can be deployed, such that the location of the person's device (such as a smartphone) can be identified. The location of the device can then be associated with a camera image from the same location to yield a picture of the same individual. The location of a camera image can be known by using a known position of the camera (for example, if an associated VM device 100 has a GPS module or of the position is otherwise known). The position of the image relative to the camera can be known using calibration. If there is only one person at the identified location, the image of that person can be associated with the MAC address.

Other forms of data, such as voice and payment information, can also be associated with an individual in a similar manner. For example, cameras directed toward a payment location such as a cashier or checkout line can capture images of a visitor while they are paying. Thus, the payment information can be automatically associated with an image of the person paying at the same time and place.

The various data identifying a particular individual can be combined to generate a profile of the individual. As discussed further herein, such profiles can be used to analyze and develop data regarding the visitors at a venue and provide information, coupons, and other forms of advertisements to particular individuals.

Visual data can be analyzed to identify individuals in a variety of ways. For example, in some embodiments the visual/image data can be analyzed by computers associated with the VM device 100. These computers can be on-site, at the venue, or at a remote location. In some embodiments, algorithms can be used to automatically identify the individuals by their images in real-time.

The algorithms can optionally be developed using machine learning techniques such as artificial neural networks. For example, the algorithm can be taught using multiple images or videos that are already known to include people. The computer can then be trained to identify whether the image or video includes a person or does not. In further embodiments, the algorithm can be trained to identify additional characteristics such as how many people are present, what the people are doing, and whether people from different images or videos are the same person. Notably, in many of the images a face might not be visible, such that facial recognition cannot always be used to identify individuals.

In some embodiments, a set of images and associated details (such as whether a person is present in the image, what they are doing, etc.) can be developed using a set of CAPTCHAs. Images or videos of people taken using the VM devices 100 can be presented to human testers, such as internet users, as a CAPTCHA. If multiple testers identify an image or video as including a person, showing a person doing a particular action, or similar characteristics, the consensus can be used to verify the validity of the result. More specifically, in some embodiments a portion of the image can be specified and a tester can be asked if that specified portion includes a person (or if the person is performing a particular action, etc.). It will be understood that similar techniques can be used with video or audio to train a machine learning algorithm.

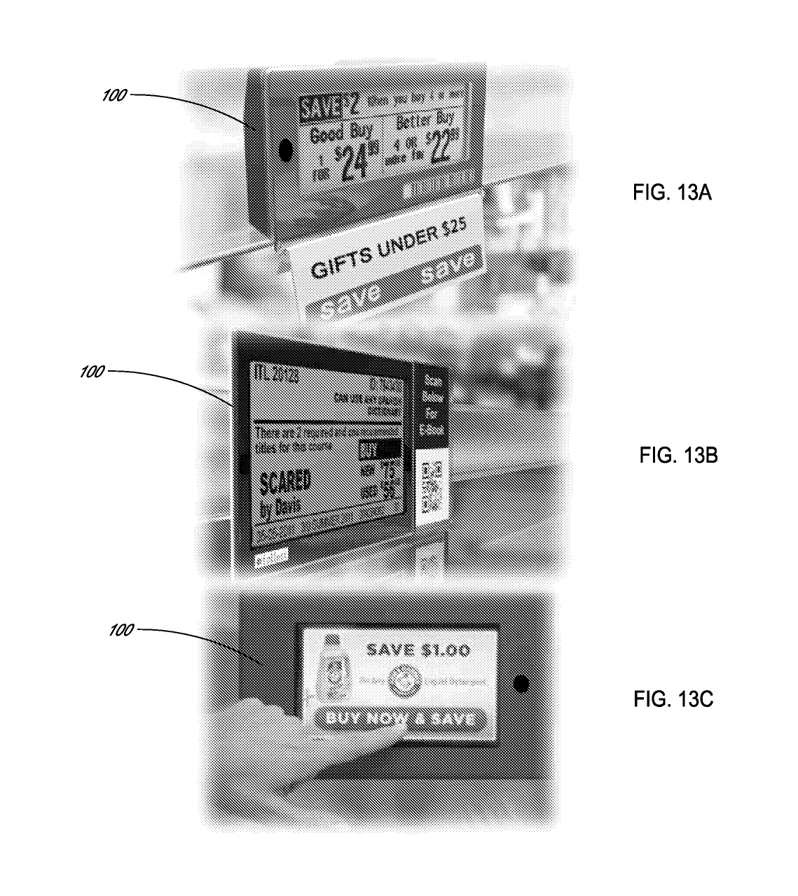

In further embodiments, VM devices 100 can also be used as smart labels in venues such as a retail venue to form a smart label system. As shown in FIGS. 13A-13C the VM device 100 can be a smartphone or otherwise have the general shape of a smartphone, including a screen, camera, and other features discussed herein. The screen can be used to display information about a particular product, such as a product on the shelves. For example, the screen might display the name, price, and other details about a particular item. Advantageously, when items and/or prices are changed, the screen can then be easily updated electronically through electronic communications between the VM devices used as smart labels and a separate computer system. In some embodiments, prices can then be updated frequently (such as daily or hourly) according to changing demand, supply, promotions, or other factors. In some embodiments, short term sales on one or more items can be started and/or ended automatically through such electronic communications without requiring an individual to manually update labels throughout the venue.

Further, when the VM device 100 is used as a smart label it can also provide interactive information to a visitor. For example, if the VM device 100 includes a touchscreen, a visitor can interact with it to find additional information such as nutrition facts, related items the visitor might also wish to purchase, and similar information. The VM device 100 can also allow a visitor to request assistance, such that an employee at the venue can be paged to a particular location to assist the visitor and answer particular questions they have.

In even further embodiments, the VM device 100 used as a smart label can provide auditory information to a visitor. For example, the information described herein can be provided in audio. In some embodiments, this can be provided when requested by a visitor, either by interaction with a touchscreen on the device, a vocal request (received by a microphone on the device), or other methods.

Further, as discussed above, a person near the relevant smart label can potentially be identified. Based on information about the visitor such as their previous purchasing history and the like, discounts, coupons, specifically-tailored information about the product, or other things can be displayed to the visitor. In some embodiments, this information can be delayed, such that incentives such as a discount or coupon are only provided if the user does not immediately take the relevant item for sale off the shelf. These operations can be performed automatically, in real-time, for every visitor in the venue.

Additionally, the positioning of VM devices 100 as a smart label can have various benefits. The smart label can be positioned to easily identify a visitor directly in front of it (for example, using image or WiFi data). If the visitor is directly in front of the smart label and remains in that position for an extended period of time, that visitor can be identified as somebody potentially interested in the product at that same position. Interest can also be identified if the visitor interacts with the smart label, takes an item off the shelf, or other relevant actions. Further, as discussed herein, the visitor with such interest can be identified and their interest in various items and their ultimate purchase can be tracked and combined into a single profile that can be stored and used.

Additionally, cameras placed on a VM device 100 positioned as a smart label can monitor the status of other items. For example, when not obscured by a visitor, the VM device 100 can view items on an opposite side of a shopping aisle. With a greater distance and a different angle, a VM device 100 on the opposite side of an aisle might provide a better view of the actions taken by a visitor viewing the relevant items. Thus, data can be combined to better identify the visitor's actions.

Even further, in some embodiments a VM device 100 can view the inventory of particular items on a shelf. For example, the device can capture images indicating if all the items of a particular type on a shelf have been removed. In such an event, a signal can optionally be sent to a worker at the venue indicating that the relevant shelf should be restocked. Further, in some embodiments this information can also be sent to inventory management systems or relevant workers, indicating that more of the item should be ordered from suppliers. Notably, this can be done automatically in real-time, allowing items to be restocked faster than they would be if inventory were observed by a person.

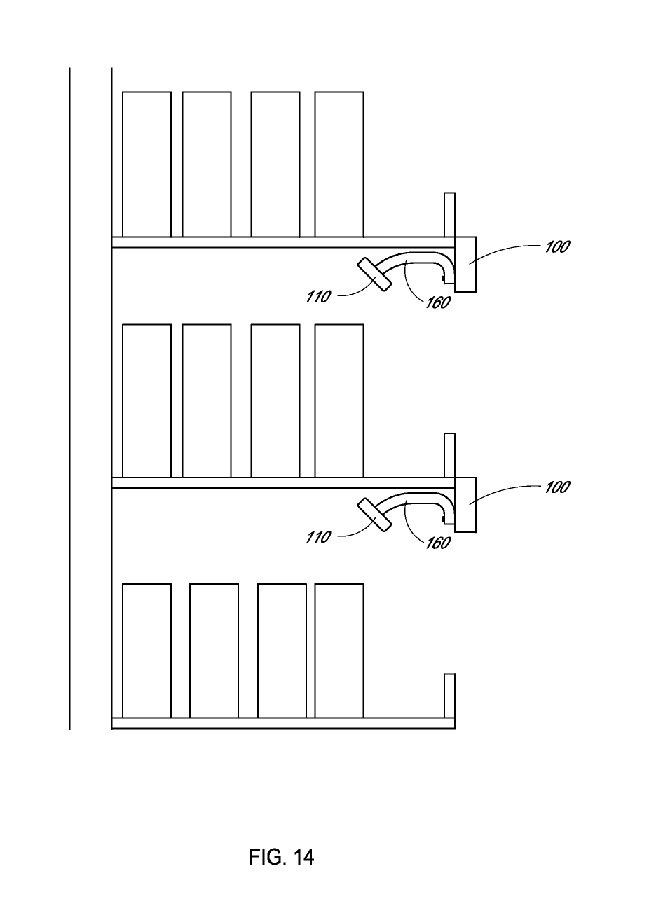

In some embodiments, inventory on a given shelf can be identified using images from a VM device 100 (such as a smart label device) on an opposite side of an aisle. In other embodiments, the VM device 100 can include a camera (such as an eyestalk) within a shelf, as shown in FIG. 14, such that the device can see how many items are on the shelf, even if they are lined-up such that their quantity can't be determined when viewing them from across the aisle. In such embodiments, the precise quantity of items on each shelf can be transmitted to the systems discussed herein.

Advantageously, combining this information with real-time sales data can allow the system to track inventory from the shelf to the point of sale in real-time. In some embodiments, loss of inventory (for example, by theft or destruction) can be discovered by comparing reduced inventory on store shelves with sales at approximately the same time. If the reduced inventory does not match sales, some form of loss and the approximate time of its occurrence can be indicated to a user. When image data is stored, the system can identify a particular person who picked-up such a lost item during a similar time period, indicating an individual who might have caused the loss.

Additionally, the VM devices 100 can be used for planogram compliance, particularly when positioned as a smart label. For example, the visual data from the VM device 100 can be used to determine various aspects about product positioning and placement such as that the product is facing the correct direction and is oriented correctly (not upside down, label facing the customer, etc.), an ideal quantity of product is present, that products are placed on the correct shelves or racks, etc. Further, in some embodiments the VM devices 100 and associated systems can alert a worker at a venue when items are not in planogram compliance such that corrections can be made in real-time.

Further, in some embodiments the VM device 100 can be configured to provide information to a visitor about other products available at a venue. For example, the camera on the VM device 100 can act as a barcode reader, such that a visitor can receive information about products from another part of the store. Even further, in some embodiments image recognition can be used to identify a product without use of a barcode. Even further, in some embodiments, information about the product can be requested by identifying the product using a touchscreen or providing auditory commands to the VM device 100.

There are many different applications of the VM device 100 and the methods associated therewith, and many other applications can be developed using the VM device 100 and the software provided therein and in the cloud.

The VM devices 100 and associated systems discussed herein can also be used with various data analysis tools. It will be understood that the numerous sensors discussed herein can produce a large amount of data, such as image data, video data, audio data, WiFi data, and counting data that might be derived therefrom.

Such tools can be found in other contexts. For example, recently the Internet has driven tremendous growth in economics worldwide including production of goods, advertising, and scientific research. The massive amount of investment in Internet infrastructure over the past few decades has resulted in a wide variety of website usage logging, monitoring, and support tools in both the closed and open-source world. Some examples are Apache or Microsoft IIS log files, standard log file analysis tools such as “analog”, or services such as Google Analytics. In all of these cases, website developers utilize log files, databases, and HTTP protocols and create custom HTML or JavaScript code (“trackers”) that enable website analytic services to be informed in real-time each time a user visits a website. This is typically done using a 1-pixel invisible image or a JavaScript hook.

While industry competitors typically try to build entirely new analytics infrastructures to support traffic analysis, brick-and-mortar stores have only recently begun to gain sufficient computer processing power and Internet capability to make some use of real-time analytics.

The present disclosure includes novel and powerful counting systems and methods where internet requests such as normal HTTP web requests are utilized to encode counting data for events other than website hits and other internet traffic. However, it will be understood that counting data can be encoded in other forms of data, such as other internet request protocols or types of data for which analytics solutions are available to process the data.

In one embodiment of the present disclosure, a counting device (such as the VM devices 100 discussed herein or systems thereof) is coupled to the Internet directly or indirectly via conventional connections such as those discussed herein. The counting device can be used to count, for example, objects such as people or cars entering or exiting a venue or premises (such as a store) or passing by or crossing an actual or virtual geographical feature. Examples of such a counting device, its configuration and methods of operation can be found in commonly owned U.S. patent application Ser. No. 13/727,605, the entirety of which is incorporated by reference herein. For example, visual data from a VM device 100 can be used to determine that a person or vehicle has entered or exited a venue, or a certain section of a venue such as an aisle of the venue. Each instance of a person entering and/or exiting can be counted as a separate event by the counting device. More generally, the VM device 100 can include sensors that collect data related to the physical presence or activity of a visitor. This data can be used to determine certain physical events that may occur at a venue, which can be counted as further described below.

The inventors of the present application discovered that the counting devices for use in venues as discussed herein can be mathematically similar or identical to internet traffic counting devices such as a website hit counting device. For example, the most general way to describe counting is by referring to the field of “Measurement Theory,” which can be defined as the thought process and interrelated body of knowledge that form the basis of valid measurements. “Measurement” is the assignment of numbers to events according to rules. This definition includes but is not limited to technical or mathematical considerations. Putting aside the human and practical factors involved in measurement theory, the theoretical or mathematical core of the subject is known by the terser name “Measure Theory.” Measure theory is the branch of mathematics concerned with sharpening the meaning of the technical term “measure.” A “measure” on a set is a systematic way to assign a number to each subset that may be intuitively interpreted as a kind of “size” of the subset. The observable universe defines a set under discussion. Examples of common measures are cardinality, length, weight, amount of something, or indeed any event that can be observed and/or counted. Events can come from all angles. For ease of discussion, movements of people or cars are used as examples to illustrate embodiments in the present disclosure. However, it will be understood that other events could be counted herein, such as items removed from a shelf, purchases made, etc.

A specific area in space (such as a doorway that visitors pass through) combined with a specific range of time (such as between 8 pm and 8:15 pm) can begin to define a subset of events such as: how many people traveled through the doorway in this time. The problem can be solved in a number of ways. One way is by collecting video evidence. Further restricting the counting by directional requirements (to distinguish entrances from exits), avoiding double counting (recognizing when the same person enters and then exits, or perhaps enters/exits again), or other rules can also be used to further categorize the counted data. In any case, this data can still come in a form with an intuitive core that is common to similar devices such as a turn-style that can be used to tabulate counts. One example of an intuitive core principle of measure theory is that the number of people measured between 8:00:00 and 8:10:00 added to the number of people measured between 8:10:00 and 8:15:00 should be equal to the number of people measured between 8:00:00 and 8:15:00. This is one intuitive conservation invariant that is fundamental to measure theory and is technically called “Countable additivity.” Another important point of measure theory is that no counts may be negative and this is called the “non-negativity” principle of measure theory. This means that the device should not count less than zero (0) people in the case of people counting. Of course, similar arguments apply equally to cars or anything else that might be counted. Therefore the same general mathematical rules of measure theory apply to website hit counters as much as car counting or person counting devices.

However, in some embodiments the data can be combined in ways that may violate some of these rules. For example, in some embodiments it may be desirable to count how many people are currently within a venue. One could determine this by separately counting the number of people that have entered and the number of people that have exited, and subtracting to determine the number of people currently inside. That method can maintain the “non-negativity” principle, as the number of people who have entered and the number of people who have exited never decreases, although the difference between the two numbers can decrease. However, in other embodiments the data measured can be a net flux of people into the venue (instead of separately counting the number of people entering and exiting). In this situation, people exiting can be counted negatively, such that if two people leave the count decreases by two. Further, if people were in the store before counting began, a negative total flux can result when more people exit than have entered. It will be understood that the rules can also be violated in other situations. However, to conform to data analysis tools, it may be preferable to choose measures or counting mechanisms and data that fit within these rules.

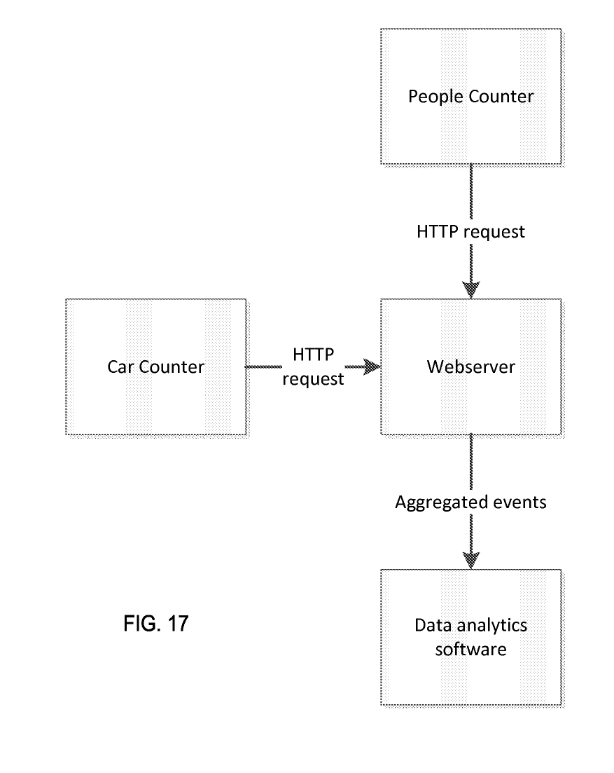

In some embodiments of the present disclosure, the counting devices are further configured to convert a detected real-life physical event count (such as people entering/exiting a venue) into countable electronic internet protocol events such as web-clicks over an HTTP request to a (potentially preconfigured) website URL that encodes information about the count-event, or more generally as electronic internet events or requests at an internet location (such as a website or webpage). So, for example, in one embodiment, an optical person-counting and/or car-counting device is configured to also act as a web browser over the network using, for example, the common CURL library. Even though it is using a camera to count people and/or cars, the count data may be transmitted and recorded using normal website traffic measurement infrastructure. For example, as shown in FIG. 17, each time a counting device detects a person or car passing by a physical or virtual landmark (e.g., the store front of “Know Knew Books” store), it can create a network request for the web page at the following URL such that each count the device generates is converted to a hit to the webpage:

http://baysensors.com/knowknewbooks/personentered.html

This request can be automatically and conveniently logged on the webserver hosting the web page. Similar methods can be used to count other distinct types of physical events at a venue such as when a person leaves, for example, using a webpage:

http://baysensors.com/knowknewbooks/personexited.html

Similar methods can also be used to count events at other venues:

http://baysensors.com/othervenue/personentered.html

Notably, the use of electronic internet requests to count events prevents non-negative counting in the sense that one cannot undo or remove a previously-made request. However, in some embodiments the records of the network requests can be altered to reduce the counted number of requests.

Further, the use of network requests only allows one count at a time. However, in some embodiments the request can include information indicating a higher count, such as by requesting a webpage designated as multiple instances of the counted event (e.g., http://baysensors.com/knowknewbooks/10peopleentered.html, representing 10 people entering). In other embodiments, ancillary electronic internet request information such as cookies, a source IP address, and the like can indicate a higher quantity of counts or other attributes related to the counts such as if it is a family unit, a repeat visitor, the identity of the visitor, if the visitor has recently visited other venues, the location of the venue, a sub-location within the venue, etc. In some embodiments, this ancillary information can be associated with, mimic, or be combined with ancillary information on a visitor's electronic devices such as a smartphone.

Such a system can be used to count people or cars and analyze the resulting data more easily than other techniques because there are already many highly developed analysis and reporting tools dedicated to website utilization and internet traffic. “Going” to a URL with a browser in cyberspace is logically similar to going into a store to browse in the real world and a common counting infrastructure can be utilized in both cases. Using the most common and familiar counting infrastructure decreases integration and training costs and simplifies large-scale deployments that have prevented such data collection and analysis in the past. More generally, internet traffic analytics software can be used to analyze physical, non-internet traffic and other physical, non-internet events.

In one embodiment, each time a person (or visitor) is counted an electronic internet request may be sent immediately and automatically to any user-configurable URL and then that user may utilize whatever website or internet traffic analytics software they desire to investigate the results shown in the analytics report generated by the software. Thus the count data from the counting device is converted to count data for internet requests or webpage usage hits, which can be stored for later analytics. The website administrator can decide if and how log files are created and if they should go into database form for analytics or not, etc. The counting device can thus offload or outsource these tasks in the same way that a user browsing a website does not need to worry about the database structure used on the other end to tabulate his website usage hits.

The user or website administrator can also configure the system such that data is sent immediately and automatically to the analytics software such that results can be reviewed in real-time. Notably, providing the electronic events (such as the internet requests) contemporaneously with the physical events at the venue (such as the visitor arrival) can facilitate the real-time data analytics and allow a time of the electronic event to represent the time of the physical event such that the time of the physical event can optionally be not recorded directly.

There are a variety of ways that the counting device can be interfaced to a website over the internet. One way, described above uses a counting criteria requiring a specific point in space combined with a specific set of constraints. So, for example, an access by the counting device to the URL shown above can be understood to mean “a person walked into the Know Knew Books retail outlet.” The specific point in space can be the Know Knew Books retail outlet and the specific set of constraints can be those constraints used to indicate that a person walked in (e.g., using the tripline methods discussed above). This may be considered a “unary” system and also the most precise because the exact moment of entrance of each person can be logged automatically with normal webserver logging software. Similar systems can be used to count events at other locations (e.g., another venue), sub-locations at the same venue (e.g., a specific aisle within Know Knew Books), and different events (e.g., a person leaving or making a purchase). If bandwidth or power efficiency were a concern, counts can be aggregated on the device and only sent to the web page every-so-often where often might mean every ten people, every hour, or something else as appropriate. Unfortunately, count-aggregation often places additional functional demands on the website log analytics software that might or might not be appropriate. Therefore, the simplest and most basic case of one-to-one mapping might be preferred, although many variations can also be implemented.

The systems that receive the electronic requests representative of physical events can be provided in a variety of ways. For example, in some embodiments portions of the web server can be password protected, behind a firewall, or in some other way non-public. Advantageously, this can prevent electronic requests from other sources (and not in response to an actual physical event) from contaminating the data produced by the system. Further, in some embodiments a single web server can be used to service multiple venues. Similarly, a system of web servers (optionally at different locations) can be used to service multiple venues. The system of servers can optionally be in communication with each other such that information collected at different venues can be combined.

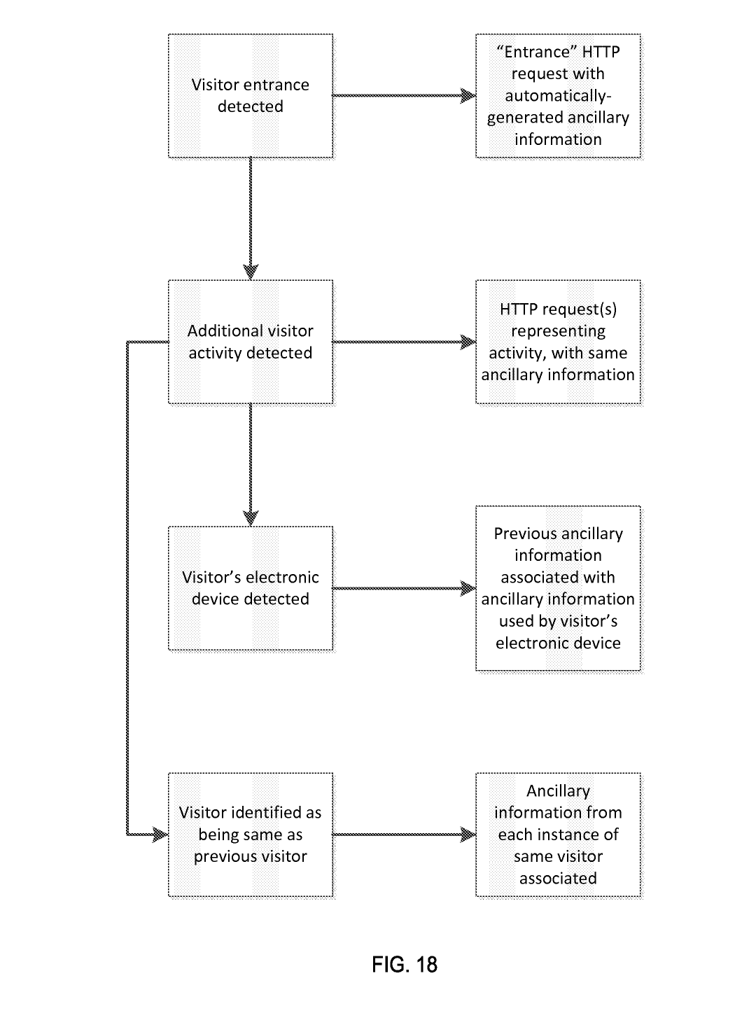

Thus, for example, if a specific visitor is identified, information about that visitor can be tracked across multiple venues, as shown in FIG. 18. This can be executed in a similar way as specific internet users are tracked across multiple electronic “venues” such as webpages. For example, a specific visitor can be automatically assigned a tracker such as a cookie or other ancillary information associated with the electronic requests such that the electronic request can indicate the identity of the visitor and be analyzed by the analytics software in a similar manner. For a specific example, when a visitor enters a venue that visitor can be assigned ancillary information such as a cookie which can be associated with an electronic internet request counting the entrance. The same ancillary information can then also be used in a subsequent electronic internet request related to the same visitor, such as when that same visitor leaves the venue. Thus, the same visitor's actions can be tracked using the ancillary information. Accordingly, visitors to multiple venues can also be identified using this ancillary information and these multiple visits can be associated with the visitor.

In even further embodiments, physical events associated with a visitor (such as entering a venue) can be associated with the visitor's real internet behavior, as also shown in FIG. 18. For example, when the identity of a physical visitor is known and the identity of an internet visitor is known to be the same person, then the single visitor's physical visitations and internet behavior (such as website browsing) can be combined. In some embodiments, the physical and electronic visitors can be identified as the same visitor using internet login data for the electronic visitor, and using payment data or loyalty account data for the physical visitor. Ancillary information used in reporting physical events can then be associated with ancillary information used in the visitor's real internet behavior, such that the internet traffic analytics software can combine both the user's physical and electronic internet behavior.

In other embodiments, physical visitors can be encouraged to connect to a local wireless (WiFi) network at the physical venue. In some embodiments, free WiFi accounts can be provided. Further, in some embodiments use of the free WiFi can require the visitor to login (for example, with a Google account, Facebook account, an account associated with the web analytics software, or a special account associated with the venue). A user login over WiFi can facilitate identifying the physical visitor by name, email address, or some other identifying characteristic that also can be used to identify the same electronic visitor even when not at the venue. Further, while the visitor uses local WiFi, their internet behavior can be monitored directly. Even further, use of the local WiFi can facilitate identification of a MAC address of the visitor's electronic devices and association of the visitor's physical location (and accordingly their image) with their electronic device (as discussed herein).

Once the electronic visitor is associated with the physical visitor, physical events by said visitor can trigger electronic requests (as discussed above) that are further configured to mimic a normal web request made by the visitor. For example, the triggered electronic requests can include cookies or other ancillary information similar to normal web requests made with an electronic device used by the visitor. Thus, the analytics software can automatically identify the electronic requests as coming from the same visitor.

This can provide a variety of advantages, associating a visitor's electronic behavior with their physical behavior. For example, in some embodiments the system can then identify when a person searches for a product on their electronic device, finds a store with that product, and subsequently actually goes to that store. In other embodiments, the system can identify when a visitor at the store searches for additional information about a particular product. Although existing GPS tracking technology on smartphones might already detect this behavior, it cannot identify more specific behavior inside the venue. Use of the VM devices 100 inside the venue can provide more specific and detailed information about the visitor's behavior that cannot be collected by sensors on usual visitor devices such as smartphones (such as if the user goes to a specific aisle or section of the venue, picks up an item, is in a group unit, purchases the product, etc.). Thus, the internet behavior and physical behavior can be combined at a more detailed level than that allowed by GPS tracking technology on smartphones.

In some embodiments, website analytics can be used to log the time and aggregate the counts according to hour, day, week, month, year, etc. Much of the pre-existing infrastructure for internet traffic analytics can be used with little or no modification as an arbitrary counting-data event store and analytic reporting system. Examples of popular website analytic software or systems include, but are not limited to, Google Analytics, “analog”, and “AWStats”. All of these may be used in the way described above to provide counting data to interested parties with little or no development integration effort. By leveraging pre-existing development work, rich and polished results can be delivered without undue development effort.

Notably, the preexisting internet traffic analytics software can be configured to analyze data and provide detailed reports to said data automatically and to a wide range of viewers in a short time. Further, the software can handle large amounts of data and traffic, such as that which may be provided from a venue that receives a large number of visitors and may wish to track a large number of events related to each individual at the venue. Such large amounts of data from a single venue would not be trackable by an individual person automatically in real-time.

The foregoing description and drawings represent the preferred embodiments of the present invention, and are not to be used to limit the present invention. For those skilled in the art, the present invention can be modified and changed. Without departing from the spirit and principle of the present invention, any changes, replacement of similar parts, and improvements, etc., should all be included in the scope of protection of the present invention.

What is claimed is:

1. A method for collecting and analyzing countable physical event data, the method comprising:
detecting a large number of countable physical events with one or more electronic sensors;
generating electronic internet requests in response to substantially all detected physical events, the electronic internet requests being representative of the detected physical events; and
receiving processed data generated from the electronic internet requests, said processed data being representative of the detected physical events.

2. The method of claim 1, further comprising receiving the electronic internet requests at one or more servers, and using internet traffic analytics software to process data related to the internet requests to generate the processed data generated from the electronic internet requests.

3. The method of claim 1, wherein the processed data is generated by third-party internet traffic analytics software.

4. The method of claim 1, further comprising generating a requestable internet location, said internet location being associated with the countable physical events and being configured to receive the electronic internet requests.

5. The method of claim 1, wherein a plurality of distinct types of countable physical events are detected with the electronic sensors and a plurality of distinct types of electronic internet requests corresponding to the distinct types of physical events are generated in response.

6. The method of claim 5, further comprising generating a plurality of requestable internet locations, said internet locations being associated with the plurality of distinct types of countable physical events and being configured to receive the electronic internet requests.

7. The method of claim 1, wherein the electronic internet requests comprise HTTP requests.

8. The method of claim 1, wherein the electronic requests are requests for one or more webpages.

9. The method of claim 1, wherein one or more of the electronic internet requests include ancillary information identifying a particular physical visitor associated with the detected physical event.

10. The method of claim 9, further comprising associating the ancillary information identifying the physical visitor with ancillary information included in electronic internet requests generated by an electronic device carried by the particular visitor.

11. The method of claim 10, further comprising providing WiFi connectivity to electronic devices carried by one or more visitors.

12. The method of claim 11, further comprising adding ancillary information to electronic internet requests generated by an electronic device carried by the one or more visitors, said added ancillary information being associated with ancillary information used with electronic internet requests representative of detected physical events related to the one or more visitors.

13. A system for analyzing countable physical event data, the system comprising:
one or more electronic devices disposed about a physical venue, the one or more electronic devices comprising one or more electronic sensors configured to detect a large number of countable physical events and further configured to automatically generate a plurality of electronic internet requests in response to detecting the countable physical events; and
an internet server configured to receive said electronic internet requests at one or more electronic internet locations associated with said physical events, the internet server further configured to use internet traffic analytics software to generate processed data indicative of the countable physical events.

14. The system of claim 13, wherein the internet server is configured to provide data related to the received electronic internet requests to the internet traffic analytics software.

15. The system of claim 13, wherein the internet server provides a requestable internet location, said internet location being associated with the countable physical events and being configured to receive the electronic internet requests.

16. The system of claim 15, wherein the internet location is a webpage.

17. The system of claim 13, wherein the one or more electronic sensors are configured to detect a plurality of distinct types of countable physical events and generate a plurality of distinct types of electronic internet requests corresponding to the distinct types of physical events in response.

18. The system of claim 17, wherein the internet server provides a plurality of requestable internet locations, said internet locations being associated with the plurality of distinct types of countable physical events and being configured to receive the electronic internet requests.

19. The system of claim 13, wherein one or more of the electronic internet requests include ancillary information identifying a particular physical visitor associated with the detected physical event.

20. The system of claim 19, wherein the ancillary information identifying the physical visitor is associated with ancillary information included in electronic internet requests generated by an electronic device carried by the particular visitor.

21. The system of claim 13, further comprising a wireless access point disposed at the venue and configured to provide WiFi connectivity to electronic devices carried by one or more visitors.

22. The system of claim 21, wherein the wireless access point is configured to add ancillary information to electronic internet requests generated by an electronic device carried by the one or more visitors using the wireless access point, said added ancillary information being associated with ancillary information used with electronic internet requests generated in response to detected physical events related to the same one or more visitors.

23. A system for analyzing countable physical event data, the system comprising:
a means for monitoring a venue and detecting a large number of physical events; and
a means for analyzing said physical events using internet traffic analytics software.
